(19) United States
(12) Patent Application Publication
(10) Pub. No.: US 2024/0286641 A1
(43) Pub. Date: Aug. 29, 2024

(54) VEHICULAR CONTROL DEVICE AND VEHICULAR CONTROL METHOD

(71) Applicant: DENSO CORPORATION, Kariya-city (JP)

(72) Inventors: Takuya KUME, Kariya-city (JP); Kazuki Izumi, Kariya-city (JP)

(21) Appl. No.: 18/655,814

(22) Filed: May 6, 2024

Related U.S. Application Data
(63) Continuation of application No. PCT/JP2022/040232, filed on Oct. 27, 2022.

(30) Foreign Application Priority Data
Nov. 11, 2021 (JP) 2021-184210
Jul. 21, 2022 (JP) 2022-116710
Oct. 21, 2022 (JP) 2022-169377

(51) Int. Cl. B60W 60/00; B60W 30/16; B60W 50/08; B60W 50/14

(52) U.S. Cl. CPC B60W 60/00133; B60W 30/162; B60W 50/082; B60W 50/14; B60W 60/0055; B60W 2050/146; B60W 2554/802

(57) ABSTRACT

A vehicular control device with which automated driving without a monitoring obligation is performed includes: a guidance provision determination unit that determines whether route guidance to a destination set by an occupant of the vehicle is under way; and a notification control unit that when the guidance provision determination unit determines that the route guidance is not under way during the automated driving without a monitoring obligation of the vehicle, causes prompting notification, which is at least either confirmation notification prompting confirmation related to setting of a route or situation notification notifying of a traveling situation, at a predetermined timing.

### CROSS REFERENCE TO RELATED APPLICATIONS

The present application is a continuation application of International Patent Application No. PCT/JP2022/040232 filed on Oct. 27, 2022 which designated the U.S. and claims the benefit of priority from Japanese Patent Application No. 2021-184210 filed on Nov. 11, 2021, Japanese Patent Application No. 2022-116710 filed on Jul. 21, 2022, and Japanese Patent Application No. 2022-169377 filed on Oct. 21, 2022. The entire disclosures of all of the above applications are incorporated herein by reference.

### TECHNICAL FIELD

The present disclosure relates to a control device for a vehicle and a control method for a vehicle.

### BACKGROUND

A related art discloses a technology for performing high-level automated driving during which a driver is not required to fulfill a surround monitoring obligation.

### SUMMARY

A vehicular control device with which automated driving without a monitoring obligation is performed includes: a guidance provision determination unit that determines whether route guidance to a destination set by an occupant of the vehicle is under way; and a notification control unit that when the guidance provision determination unit determines that the route guidance is not under way during the automated driving without a monitoring obligation of the vehicle, causes prompting notification, which is at least either confirmation notification prompting confirmation related to setting of a route or situation notification notifying of a traveling situation, at a predetermined timing.

### BRIEF DESCRIPTION OF THE DRAWINGS

FIG. 1 is a drawing illustrating an example of a general configuration of a vehicular system;

FIG. 2 is a drawing illustrating an example of a general configuration of an HCU;

FIG. 3 is a flowchart showing an example of a flow of notification control related processing at an HCU;

FIG. 4 is a drawing illustrating an example of a general configuration of an HCU;

FIG. 5 is a flowchart showing an example of a flow of notification control related processing at an HCU;

FIG. 6 is a drawing illustrating an example of a general configuration of an HCU;

FIG. 7 is a flowchart showing an example of a flow of notification control related processing at an HCU;

FIG. 8 is a drawing illustrating an example of a general configuration of a vehicular system;

FIG. 9 is a drawing illustrating an example of a general configuration of an HCU;

FIG. 10 is a flowchart showing an example of a flow of second task limitation related processing at an HCU;

FIG. 11 is a drawing illustrating an example of a general configuration of a vehicular system;

FIG. 12 is a drawing illustrating an example of a general configuration of an HCU;

FIG. 13 is a drawing illustrating an example of a general configuration of a vehicular system;

FIG. 14 is a drawing illustrating an example of a general configuration of an automated driving ECU;

FIG. 15 is a drawing explaining an example of a surrounding state image;

FIG. 16 is a drawing explaining an example of an LC restriction image;

FIG. 17 is a flowchart showing an example of a flow of LC restriction related processing at an automated driving ECU;

FIG. 18 is a drawing illustrating an example of a general configuration of a vehicular system;

FIG. 19 is a drawing illustrating an example of a general configuration of an HCU;

FIG. 20 is a drawing illustrating an example of a general configuration of a vehicular system;

FIG. 21 is a drawing illustrating an example of a general configuration of an HCU;

FIG. 22 is a drawing illustrating an example of a general configuration of a vehicular system;

FIG. 23 is a drawing illustrating an example of a general configuration of an HCU;

FIG. 24 is a drawing illustrating an example of a general configuration of a vehicular system;

FIG. 25 is a drawing illustrating an example of a general configuration of an automated driving ECU;

FIG. 26 is a drawing illustrating an example of a general configuration of a vehicular system;

FIG. 27 is a drawing illustrating an example of a general configuration of an automated driving ECU;

FIG. 28 is a drawing illustrating an example of a general configuration of a vehicular system; and

FIG. 29 is a drawing illustrating an example of a general configuration of an automated driving ECU.

### DETAILED DESCRIPTION

With respect to automated driving during which a surround monitoring obligation is not placed (also referred to as automated driving free from a monitoring obligation or automated driving without a monitoring obligation), a case where route guidance is provided and a case where route guidance is not provided are possible. In a case where route guidance is not provided, it is guessed that setting of a destination by user input is not made. Since in automated driving free from a monitoring obligation, a driver does not perform driving operation, setting may be forgotten even though a driver intends to make setting of a destination. When setting of a destination by a driver's input is not made, it is difficult for the system side of automated driving to identify the driver's desired driving route. Therefore, in automated driving free from a monitoring obligation, driving different from a driver's intention can be performed and this can lead to degradation in convenience.

Even during identical automated driving free from a monitoring obligation, it is guessed that some processing degrades a driver's convenience depending on a difference in a state related to setting of a destination.

The present disclosure provides a control device for a vehicle and a control method for a vehicle that enable degradation in convenience to be suppressed during automated driving free from a monitoring obligation. The control device for a vehicle may be referred to as a vehicular control device. The control method for a vehicle may be referred to as a vehicular control method.

According to one aspect of the present disclosure, a vehicular control device used in a vehicle with which automated driving without a monitoring obligation, which is automated driving during which a surround monitoring obligation is not imposed, is performed is provided. The vehicular control device comprises: a guidance provision determination unit that is configured to determine whether route guidance to a destination set by an occupant of the vehicle is under way; and a notification control unit that is configured to, when the guidance provision determination unit determines that the route guidance is not under way during the automated driving without a monitoring obligation of the vehicle, cause prompting notification, which is at least either confirmation notification prompting confirmation related to setting of a route or situation notification notifying of a traveling situation, at a predetermined timing.

According to one aspect of the present disclosure, a vehicular control method used in a vehicle that performs automated driving without a monitoring obligation which is automated driving during which a surround monitoring obligation is not imposed, the control method being executed by at least one processor is provided. The vehicular control method comprises: a guidance provision determination step of determining whether route guidance to a destination set by an occupant of the vehicle is under way; and a notification control step of, when it is determined that the route guidance is not under way at the guidance provision determination step during the automated driving without a monitoring obligation of the vehicle, causing prompting notification which is at least either confirmation notification prompting confirmation related to setting of a destination or situation notification notifying of a traveling situation at a predetermined timing.

According to the above-mentioned configuration, when route guidance set by an occupant of the subject vehicle is not provided during automated driving free from a monitoring obligation, prompting notification, which is at least either confirmation notification prompting confirmation related to setting of a route and situation notification notifying of a traveling situation, is made with predetermined timing. When confirmation notification prompting confirmation related to setting of a route or situation notification notifying of a traveling situation is made, the notification provides a trigger for a driver to confirm whether driving different from the driver's intention is not being performed. Therefore, when a driver can perceive that the driver is performing driving different from the driver's intention by causing prompting notification, the driver can change the driving to a driving along a route corresponding to the driver's intention. As a result, degradation in convenience can be suppressed during automated driving free from a monitoring obligation.

According to one aspect of the present disclosure, a vehicular control device used in a vehicle with which automated driving without a monitoring obligation, which is automated driving during which a surround monitoring obligation is not imposed, is performed is provided. The vehicular control device comprises: a setting state determination unit that is configured to determine a setting state which is a state related to setting of a destination of the vehicle; and an allowable range alteration unit that is configured to alter an allowable range of second tasks, which are actions other than driving permitted to a driver of the vehicle, between a first mode which is a state of the vehicle during the automated driving without a monitoring obligation with the destination set by an occupant of the vehicle and a second mode which is a state of the vehicle during the automated driving without a monitoring obligation without a destination set by an occupant of the vehicle based on the setting state determined at the setting state determination unit.

According to one aspect of the present disclosure, a vehicular control method used in a vehicle that performs automated driving without a monitoring obligation which is automated driving during which a surround monitoring obligation is not imposed, the control method being executed by at least one processor is provided. The vehicular control method comprises: a setting state determination step of determining a setting state which is a state related to setting of a destination of the vehicle; and an allowable range alteration step of altering an allowable range of second tasks which are actions other than driving permitted to a driver of the vehicle between a first mode which is a state of the vehicle during the automated driving without a monitoring obligation with the destination set by an occupant of the vehicle and a second mode which is a state of the vehicle during the automated driving without a monitoring obligation without the destination set by an occupant of the vehicle based on the setting state determined at the setting state determination step.

With respect to automated driving free from a monitoring obligation, it is guessed that a degree to which a driver is required to cope with sudden driving operation differs between a case where a destination is set by an occupant of the vehicle and a case where a destination is not set by an occupant of the vehicle. According to the configuration, to cope with the foregoing, an allowable range of second tasks, which are actions other than driving permitted to a driver of a vehicle can be varied between in mode A that is a state of a vehicle during automated driving free from a monitoring obligation with a destination set by an occupant of the vehicle and in mode B that is a state of a vehicle during automated driving free from a monitoring obligation without a destination set by an occupant of the vehicle. Therefore, an allowable range of second tasks can be varied in accordance with a degree to which a driver is required to cope with sudden driving operation. As a result, degradation in convenience can be suppressed during automated driving free from a monitoring obligation.

According to one aspect of the present disclosure, a vehicular control device used in a vehicle with which automated driving without a monitoring obligation, which is automated driving during which a surround monitoring obligation is not imposed, is performed is provided. The vehicular control device comprises: a setting state determination unit that is configured to determine a setting state which is a state related to setting of a destination of the vehicle; and a lane change restriction unit that is configured to restrict execution of a lane change of the vehicle in a case where a destination is being newly searched for in a first mode, which is a state of the vehicle during the automated driving without a monitoring obligation with a destination set by an occupant of the vehicle, or in a second mode, which is a state of the vehicle during the automated driving without a monitoring obligation without a destination set by an occupant of the vehicle or in a third mode, which is a state of the vehicle during the automated driving without a monitoring obligation, different from the first mode and the second mode, to which a transition is made when reroute, which is re-search for a new route to a destination, takes place based on the setting state determined at the setting state determination unit.

According to one aspect of the present disclosure, a vehicular control method used in a vehicle that performs automated driving without a monitoring obligation which is automated driving during which a surround monitoring obligation is not imposed, the control method being executed by at least one processor is provided. The vehicular control method comprises: a setting state determination step of determining a setting state which is a state related to setting of a destination of the vehicle; and a lane change restriction step of restricting execution of a lane change of the vehicle in a case where the destination is newly searched for in a first mode which is a state of the vehicle during the automated driving without a monitoring obligation with the destination set by an occupant of the vehicle or in a second mode which is a state of the vehicle during the automated driving without a monitoring obligation without the destination set by an occupant of the vehicle, or in a third mode which is a state of the vehicle during the automated driving without a monitoring obligation, different from the first mode and the second mode, to which a transition is made when reroute, which is re-search for a new route to a destination in the first mode, takes place based on the setting state determined at the setting state determination step.

In a case where a new destination is searched for in mode A, which is a state of a vehicle during automated driving free from a monitoring obligation with a destination set by an occupant of the vehicle, and mode B, which is a state of a vehicle during automated driving free from a monitoring obligation without a destination set by an occupant of the vehicle, a traveling direction of the vehicle must be highly probably changed. Also in mode C, which is a state of a vehicle during automated driving free from a monitoring obligation different from mode A and mode B, to which the vehicle makes a transition when reroute, which is a re-search for a new route to a destination, occurs, a traveling direction of the vehicle must be highly probably changed. When a change of traveling direction of a vehicle to a direction different from that of a lane change become necessary at a lane change time during automated driving free from a monitoring obligation, a driver can be required to cope with sudden driving operation. According to the above-mentioned configuration, to cope with the foregoing, when a change of traveling direction of a vehicle is highly probably necessary, execution of a lane change can be restricted. Therefore, during automated driving free from a monitoring obligation, a driver is less prone to be required to cope with sudden driving operation. As a result, degradation in convenience can be suppressed during automated driving free from a monitoring obligation.

The following will describe embodiments of the present disclosure with reference to the drawings. For convenience of description, any part functioning identically to a part depicted in any figure having been referred to in foregoing description will be denoted by an identical reference symbol and may not be described repeatedly in the following embodiments. For the elements denoted by the same reference symbols, the description thereof may be referred to in other embodiments.

### (First Embodiment)

### <General Configuration of Vehicular System 1>

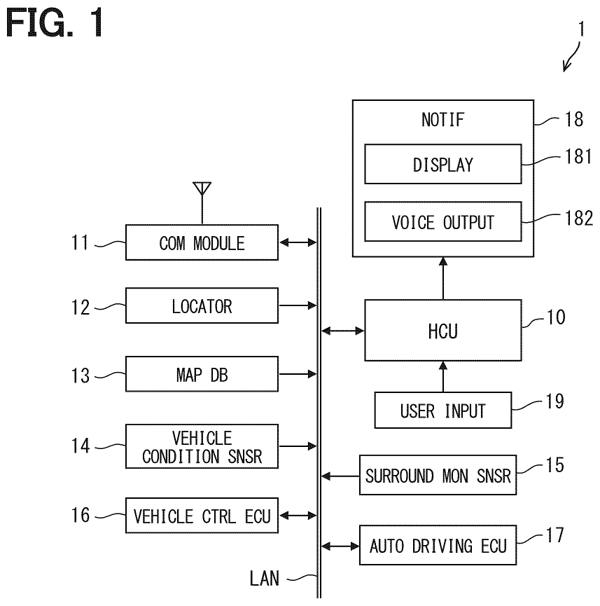

Hereafter, a description will be given to a first embodiment of the present disclosure with reference to the drawings. The vehicular system 1 shown in FIG. 1 can be used in a vehicle capable of automated driving (hereafter, referred to as an automated driving vehicle). As shown in FIG. 1, the vehicular system 1 includes: an HCU (Human Machine Interface Control Unit) 10, a communication module 11, a locator 12, a map database (hereafter, referred to as map DB) 13, a vehicle condition sensor 14, a surround monitoring sensor 15, a vehicle control ECU 16, an automated driving ECU 17, a notification device 18, and a user input device 19. For example, the present disclosure can be so configured that the HCU 10, the communication module 11, the locator 12, the map DB 13, the vehicle condition sensor 14, the surround monitoring sensor 15, the vehicle control ECU 16, and the automated driving ECU 17 are connected with an in-vehicle LAN (refer to LAN in FIG. 1). A vehicle using the vehicular system 1 need not be an automobile but in the following description, a case where the vehicular system is used in an automobile will be taken as an example.

With respect to degrees of automated driving of an automated driving vehicle (hereafter, referred to as automation levels), for example, as SAE defines, a plurality of levels can exist. The automation level can be divided, for example, into LVs 0 to 5 as described below.

LV 0 is a level at which a driver performs all the driving tasks without intervention of a system. The driving task may be rephrased to dynamic driving task. Examples of the driving tasks include, for example, steering, acceleration/deceleration, and surround monitoring. LV 0 is equivalent to so-called manual driving. LV 1 is a level at which a system assists either steering or acceleration/deceleration. LV 1 is equivalent to so-called manual driving. LV 2 is a level at which a system assists both steering and acceleration/deceleration. LV 2 is equivalent to so-called partial driving automation. LVs 1 to 2 are also defined as part of automated driving.

For example, automated driving of LV 1 to 2 is automated driving during which a driver has an obligation to do monitoring related to safe driving (hereafter, simply referred to as monitoring obligation). An example of monitoring obligation is visual surround monitoring. The automated driving of LVs 1 to 2 can be rephrased to second task prohibited automated driving. The second task is an action other than driving permitted to a driver and is a predetermined specific action. The second task can also be rephrased to secondary activity, other activity, or the like. The second task should not prevent a driver from coping with a driving operation handover request from an automated driving system. Assumed examples of second tasks include viewing of such contents as videos, operation of a smartphone or the like, such actions as reading and taking a meal.

The automated driving of LV 3 is at a level at which a system can perform all the driving tasks under a specific condition and a driver performs driving operation in emergency. When a driving change is requested from a system during automated driving of LV 3, a driver is required to be capable of swiftly coping therewith. This driving change can also be rephrased to a transfer of a surround monitoring obligation from a vehicle-side system to a driver. LV 3 is equivalent to so-called conditional driving automation. LV 3 includes an area limited LV 3 at which automated driving is limited to a specific area. Highway can be included in the specific area cited here. The specific area may be, for example, a specific lane. Another example of LV 3 is a congestion limited LV 3 at which automated driving is limited to a time of congestion. The congestion limited LV 3 can be so configured that automated driving is limited to, for example, a time of congestion on a highway. An automobile road may be included in the highway.

The automated driving of LV 4 is at a level at which a system can all the driving tasks except on a road the system cannot cope with and in such specific situations as an extreme environment. LV 4 is equivalent to so-called high driving automation. The automated driving of LV 5 is at a level at which a system can perform all the driving tasks in every environment. LV 5 is equivalent to so-called full driving automation. For example, the automated driving of LVs 3 to 5 is defined as automated driving during which a driver does not have a monitoring obligation. That is, the automated driving of LVs 3 to 5 is equivalent to automated driving free from a monitoring obligation. The automated driving of LVs 3 to 5 is equivalent to automated driving without a monitoring obligation. The automated driving of LVs 3 to 5 can be rephrased to second task permitted automated driving. Of the automated driving of LVs 3 to 5, the automated driving of LV 4 or higher level is equivalent to automated driving during which a driver is permitted to sleep. That is, the automated driving of LV 4 or higher level is equivalent to sleep-permitted automated driving. Of the automated driving of LV 3 to 5, the automated driving of Level 3 is equivalent to automated driving during which a driver is not permitted to sleep. That is, the automated driving at Level 3 is equivalent to sleep-prohibited automated driving.

In an automated driving vehicle according to the present embodiment, an automation level is switchable. The present embodiment may be so configured that only some of LVs 0 to 5 is switchable. In the description of the present embodiment, a case where the automated driving of LV 3 or higher levels and automated driving of less than LV 3 are switchable therebetween will be taken as an example. Manual operation of LV 0 may be included in automated driving of less than LV 3.

The communication module 11 sends and receives information to and from a center external to the subject vehicle by radiocommunication. That is, the communication module performs wide area communication. The communication module 11 receives information delivered from a center by wide area communication. The communication module 11 may send and receive information to and from another car by radiocommunication. That is, the communication module may perform inter-vehicle communication. The communication module 11 may send and receive information to and from a roadside device installed on the roadside by radiocommunication. That is, the communication module may perform vehicle roadside communication. To perform vehicle roadside communication, the communication module 11 may receive information of a nearby vehicle of the subject vehicle sent from the nearby vehicle through a roadside device. The communication module 11 may receive information of a nearby vehicle of the subject vehicle sent from the nearby vehicle by wide area communication through a center.

The locator 12 includes a GNSS (Global Navigation Satellite System) receiver and an inertia sensor. The GNSS receiver receives a positioning signal from a plurality of positioning satellites. The inertia sensor includes, for example, a gyro sensor and an acceleration sensor. The locator 12 combines a positioning signal received by the GNSS receiver and a measurement result from the inertia sensor and thereby successively potions a vehicle position of the subject vehicle mounted with the locator 12 (hereafter, referred to as subject vehicle position). The subject vehicle position can be expressed by, for example, coordinates of latitude and longitude. To position a subject vehicle position, the present embodiment may be so configured as to use a mileage as well determined from a signal successively outputted from a vehicle speed sensor described later, mounted in the vehicle.

The map DB 13 is a nonvolatile memory and holds highly accurate map data. The highly accurate map data is map data more accurate than map data used in route guidance in a navigation function. The map DB 13 holds also map date used in route guidance (hereafter, referred to as route guidance map data).

The highly accurate map data includes information usable in automated driving, for example, three-dimensional shape information of a road, number of lanes information, information indicating a traveling direction permitted for each lane. In addition, the highly accurate map data may also include, for example, information of node points indicating the positions of both ends with respect to such a road marking as a lane marking. The locator 12 may so configured as to use three-dimensional shape information of a road, not to use the GNSS receiver. For example, the locator 12 may be so configured as to use three-dimensional shape information of a road and a detection result from LIDAR (Light Detection and Ranging/Laser Imaging Detection and Ranging), which detects a point group of feature points of a road shape and a structure, or such a surround monitoring sensor 15 as a surround monitoring camera to identify a subject vehicle position. Three-dimensional shape information of a road may be generated based on a captured image by REM (Road Experience Management).

The route guidance map data contains such map data as link data and node data. Link data is composed of varied data including: a link ID which is a unique number identifying a link, a link length indicating a length of a link, a link direction, shape information of a link, the node coordinates of the start point and end point of a link, and road attributes. Road attributes include road name, road type, road width, speed limit value, and the like. Meanwhile, node data is composed of varied data including: node ID which is a unique number assigned to each node on a map, node coordinates, node name, node type, connection link ID describing a link ID of a link connected to a node, intersection type, and the like.

Map data distributed from an external server may be received by wide area communication through the communication module 11 and be stored in the map DB 13. In this case, the present embodiment may be so configured that a volatile memory is used for the map DB 13 and the communication module 11 successively acquires map data of an area corresponding to a subject vehicle position.

The vehicle condition sensor 14 is a sensor group for detecting various statuses of the subject vehicle. The vehicle condition sensor 14 includes the vehicle speed sensor, and the like. The vehicle speed sensor outputs a vehicle speed pulse. The vehicle condition sensor 14 outputs detected sensing information to the in-vehicle LAN. The present embodiment may be so configured that sensing information detected by the vehicle condition sensor 14 is outputted to the in-vehicle LAN through ECU mounted in the subject vehicle.

The surround monitoring sensor 15 monitors an environment surrounding the subject vehicle. For the example, the surround monitoring sensor 15 detects such an obstacle surrounding the subject vehicle as a pedestrian, such a moving object as another vehicle, and such a stationary object as a falling object on a road. In addition, the surround monitoring sensor detects such a road marking as a traveling lane marking surrounding the subject vehicle. The surround monitoring sensor 15 is, for example, a surround monitoring camera that picks up an image of a predetermined range surrounding the subject vehicle, or such a sensor as a millimeter wave radar, a sonar, LIDAR, or the like that sends a prospecting wave to a predetermined range surrounding the subject vehicle. The surround monitoring camera successively outputs a captured image successively picked up to the automated driving ECU 17 as sensing information. Such a sensor as a sonar, a millimeter wave radar, LIDAR, or the like that sends a prospecting wave successively outputs a scanning result based on a reception signal obtained when a reflected wave reflected by an obstacle is received to the automated driving ECU 17 as sensing information. The present embodiment may be so configured that sensing information detected by the surround monitoring sensor 15 is outputted to the automated driving ECU 17 without intervention of the in-vehicle LAN.

The vehicle control ECU 16 is an electronic control unit that controls driving of the subject vehicle. The driving control includes acceleration/deceleration control and/or steering control. The vehicle control ECU 16 includes a steering ECU that exercises steering control, a power unit control ECU that exercises acceleration/deceleration control, a brake ECU, and the like. The vehicle control ECU 16 outputs a control signal to each of driving control devices, such as an electronically controlled throttle, a brake actuator, and an EPS (Electric Power Steering) motor, and the like mounted in the subject vehicle and thereby exercises driving control.

The automated driving ECU 17 includes, for example, a processor, a memory, I/O, and a bus connecting these elements and performs processing related to automated driving by executing a control program stored in the memory. The memory cited here is a non-transitory tangible storage medium that non-transitionally stores a computer-readable program and data. The non-transitory tangible storage medium is implemented by a semiconductor memory, a magnetic disk, or the like. The automated driving ECU 17 includes a travel environment recognition unit, a behavior determination unit, and a control implementation unit as function blocks.

The travel environment recognition unit recognizes a travel environment of the subject vehicle from a subject vehicle position acquired from the locator 12, map data acquired from the map DB 13, and sensing information acquired from the surround monitoring sensor 15. For example, the travel environment recognition unit uses these pieces of information to recognize a position, a shape, and a moving state of an object in proximity to the subject vehicle and generates a virtual space reproducing the actual travel environment. The travel environment recognition unit can recognize a subject vehicle position on a map from the subject vehicle position and map data. In a case where positional information, speed information, and the like of a nearby vehicle or the like can be acquired through the communication module 11, the travel environment recognition unit can use also these pieces of information to recognize a travel environment.

Further, the travel environment recognition unit can also distinguish a manual driving area (hereafter, referred to as MD area) in a travel area of the subject vehicle. The travel environment recognition unit can also distinguish an automated driving area (hereafter, referred to as AD area) in a travel area of the subject vehicle. The travel environment recognition unit can also distinguish an ST section and a non-ST section, described later, in an AD area.

The MD area is an area where automated driving is prohibited. In other words, the MD area is an area where a driver is required to perform all of longitudinal direction control, lateral direction control, and surround monitoring in the subject vehicle. The longitudinal direction is a direction agreeing with the front and rear direction of the subject vehicle. The lateral direction is a direction agreeing with the width direction of the subject vehicle. The longitudinal direction control is equivalent to acceleration/deceleration control of the subject vehicle. The lateral direction control is equivalent to steering control of the subject vehicle. For example, an ordinary road can be taken as an MD area. The MD area can also be defined as a traveling section of an ordinary road for which highly accurate map data has not been prepared.

The AD area is an area where automated driving is permitted. In other words, the AD area is an area where the subject vehicle can substitute with respect to one or more of longitudinal direction control, lateral direction control, and surround monitoring. For example, a highway can be taken as an AD area. The AD area can also be defined as a traveling section for which highly accurate map data has been prepared. For example, the automated driving of area limited LV 3 can be permitted only on a highway. The automated driving of congestion limited LV 3 is permitted only at a time of congestion in an AD area.

The AD area is divided into ST section and non-ST section. The ST section is a section where the automated driving of area limited LV 3 (hereafter, referred to as area limited automated driving) is permitted. The non-ST section is a section where the automated driving of LV 2 or lower level and the automated driving of congestion limited LV 3 can be performed. In the present embodiment, the non-ST section where the automated driving of LV 1 is permitted and the non-ST section where the automated driving of LV 2 is permitted are not separated from each other. A section that is not equivalent to an ST section in an AD area can be taken as a non-ST section.

The behavior determination unit switches the control main body of a driving operation between a driver and a system of the subject vehicle. When the control of a driving operation is on the system side, the behavior determination unit determines a traveling plan according to which the subject vehicle is driven based on a result of recognition of a travel environment by the travel environment recognition unit. As traveling plans, a long and mid-term traveling plan and a short-term traveling plan are generated. In a long and mid-term traveling plan, a route for making the subject vehicle go to a set destination. The route is a route composed of a plurality of links. The automated driving ECU 17 can generate this route as in route search of a navigation function. This route search can be performed, for example, by cost accounting by the Dijkstra's algorithm. In cost accounting by the Dijkstra's algorithm, a link cost of a link that meets such a search condition as distance preference, time preference, or the like is set to a small value. Then, a route in which a value of a link cost is more reduced is searched for as a recommended route.

For example, when an input of a destination has been accepted from an occupant at the user input device 19 described later, the behavior determination unit can set the inputted destination as a destination of a route. The behavior determination unit can acquire an input of a destination accepted at the user input device 19 through the HCU 10. When an input of a destination has been accepted from an occupant at a terminal external to the subject vehicle, the behavior determination unit may set the inputted destination as a destination of a route. The behavior determination unit can acquire an input of a destination accepted at a terminal external to the subject vehicle through the communication module 11. A user who inputs a destination of the subject vehicle at a terminal external to the subject vehicle is also considered as an occupant of the subject vehicle.

When an input of a destination has not been accepted from an occupant, the behavior determination unit can estimate a tentative destination (hereafter, referred to as tentative destination) based on a driving history of the subject vehicle and set the tentative destination as a destination. In this case, a destination high in driving frequency in the driving history with respect to a subject vehicle position positioned by the locator 12, the present time, the present day of the week, and the like can be estimated as tentative destination. The driving history may be so configured as to be stored in a nonvolatile memory equipped in the subject vehicle or may be so configured as to be stored at a center through the communication module 11. When a driving history of the subject vehicle is stored at a center, the behavior determination unit can estimate a tentative destination based on the driving history of the subject vehicle by accessing the center through the communication module 11.

In a short-term traveling plan, the behavior determination unit uses a generated virtual space in proximity to the subject vehicle to generate a planned traveling path for implementing driving in accordance with a long and mid-term traveling plan. Specifically, execution of steering for lane change, acceleration/deceleration for speed control, steering and braking for obstacle avoidance, and the like is determined.

Further, the behavior determination unit changes an automation level of the subject vehicle as required. The behavior determination unit determines whether an automation level can be increased. For example, when the subject vehicle moves from an MD area to a non-ST section in an AD area, it can be determined that a change from manual driving of LV 0 to the automated driving of LV 2 or lower level is possible. When the subject vehicle moves from an MD area to a ST section in an AD area, it can be determined that a change from the automated driving of LV 0 to the automated driving of area limited LV 3 is possible. When the subject vehicle moves from a non-ST section in an AD area to an ST section, it can be determined that a change from the automated driving of LV 2 or lower level to the automated driving of LV 3 is possible. When the subject vehicle is located in an AD area, an automation level is LV 2 or lower level, and all the conditions for congestion limited LV 3 are met, it can be determined that a change from the automated driving of LV 2 or lower level to automated driving of congestion limited LV 3 is possible. Aside from the foregoing, when a starting condition for LV 4 is met, it can be determined that a change from LV 3 or lower level to LV 4 is possible. When it is determined that increase in automation level is possible and the increase in automation level is approved by a driver, the behavior determination unit can increase the automation level.

When it is determined that reduction in automation level is required, the behavior determination unit can reduce the automation level. Cases where it is determined that reduction in automation level is required are when an override is detected, a planned driving change time, and an unplanned driving change time. The override is an operation for a driver of the subject vehicle to voluntarily gain control of the subject vehicle. In other words, the override is the subject vehicle driver's intervention into operation. The planned driving change is a planned driving change according to a determination by a system. The unplanned driving change is an unplanned, sudden driving change according to a determination by a system.

When the control of driving operation is on the system side of the subject vehicle, the control implementation unit exercises acceleration/deceleration control, steering control, and the like of the subject vehicle according to a driving plan determined at the behavior determination unit in cooperation with the vehicle control ECU 16. The control implementation unit exercises, for example, ACC (Adaptive Cruise Control) control, LTA (Lane Tracing Assist) control, and LCA control (Lane Change Assist).

The ACC control is control for implementing constant-speed traveling of the subject vehicle or following traveling to a vehicle ahead. In following traveling, acceleration/deceleration control is so exercised as to maintain an intervehicle distance between the subject vehicle and the nearest vehicle ahead at a target intervehicle distance. A target intervehicle distance can be set according to a speed of the subject vehicle or by any other like means. The LTA control is control for maintaining in-lane traveling of the subject vehicle. In LTA control, steering control is so exercised as to maintain in-line traveling of the subject vehicle. The LCA control is a control to cause the subject vehicle to make an automatic lane change from the subject vehicle's lane to an adjacent lane. In LCA control, acceleration/deceleration control and steering control are exercised to make a lane change.

The notification device 18 is provided in the subject vehicle and makes a notification to a driver of the subject vehicle. The notification device 18 makes a notification in accordance with an instruction from the HCU 10. The notification device 18 only has to make a notification at least to a driver. The notification device 18 may make a notification also to a passenger in addition to a driver. The notification device 18 includes a display device 181 and a voice output device 182.

The display device 181 makes a notification by displaying information. For the display device 181, for example, a meter MID (Multi Information Display), CID (Center Information Display), or HUD (Head-Up Display) can be used. The meter MID is a display unit provided in front of the driver's seat in the vehicle compartment. For example, the present embodiment can be so configured that the meter MID is provided in a meter panel. The CID is a display unit disposed in the center of the instrument panel of subject vehicle. The HUD is provided in, for example, the instrument panel in the vehicle compartment. The HUD projects a display image formed by a projector onto a projection area defined in a front wind shield as a projection member. The light of an image reflected to the vehicle compartment side by the front wind shield is perceived by a driver seated in the driver's seat. As a result, the driver can view a virtual image of a display image formed ahead of the front wind shield, partly overlapped with the foreground. The HUD may be so configured as to project a display image onto a combiner provided in front of the driver's seat in place of the front wind shield. The voice output device 182 makes a notification by outputting voice. Examples of the voice output device 182 include a speaker and the like.

The user input device 19 accepts an input from a user. An operating device that accepts an operation input from a user can be used as the user input device 19. The operating device may be a mechanical switch or may be a touch switch integrated with the display device 181. The user input device 19 need not be an operating device that accepts an operation input as long as the device accepts an input from a user. For example, the user input device may be a voice input device that accepts a command input by voice from a user.

The HCU 10 is configured based on a computer including a processor, a volatile memory, a nonvolatile memory, I/O, and a bus connecting these items. The HCU 10 is connected to the notification device 18, the user input device 19, and in-vehicle LAN. The HCU 10 controls notification by the notification device 18 by executing a control program stored in a nonvolatile memory. The HCU 10 is equivalent to the control device for a vehicle. In the description of the present embodiment, a case where in automated driving, the HCU 10 is used at least in a vehicle capable of automated driving free from a monitoring obligation will be taken as an example. A configuration of the HCU 10 related to control of notification at the notification device 18 will be described in detail below.

### <General Configuration of HCU 10>

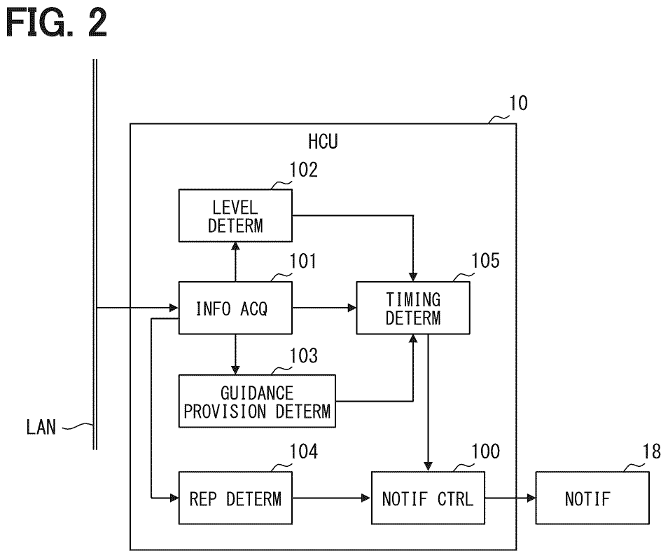

A description will be given to a general configuration of the HCU 10 with reference to FIG. 2. In relation to control of notification at the notification device 18, as shown in FIG. 2, the HCU 10 includes, as functional blocks, a notification control unit 100, an information acquisition unit 101, a level determination unit 102, a guidance provision determination unit 103, a repetition determination unit 104, and a timing determination unit 105. Execution of processing of each functional block of the HCU 10 by a computer is equivalent to execution of a control method for a vehicle. Part or all of the functions executed by the HCU 10 may be configured by hardware using one or more ICs or the like. Part or all of the functional blocks provided in the HCU 10 may be implemented by a combination of execution of software by the processor and a hardware member.

The information acquisition unit 101 acquires information inputted from the outside of the HCU 10. The information acquisition unit 101 acquires information, for example, through the in-vehicle LAN. The information acquisition unit 101 acquires, for example, a result of recognition by the travel environment recognition unit of the automated driving ECU 17. The information acquisition unit 101 acquires a result of determination by the behavior determination unit of the automated driving ECU 17. The information acquisition unit 101 acquires sensing information detected with the vehicle condition sensor 14. The information acquisition unit 101 acquires the above-mentioned driving history from a nonvolatile memory, the communication module 11, or the like equipped in the subject vehicle.

The level determination unit 102 determines an automation level of the subject vehicle at the present time. The level determination unit 102 can determine an automation level of the subject vehicle at the present time, for example, based on a result of determination of the behavior determination unit acquired from the automated driving ECU 17 by the information acquisition unit 101. In more detail, the level determination unit 102 can determine an automation level of the subject vehicle at the present time based on information of automation level change at the behavior determination unit.

The guidance provision determination unit 103 determines whether route guidance to a destination set by an occupant of the subject vehicle is under way (hereafter, referred to as occupant set route guidance under way). This processing at the guidance provision determination unit 103 is equivalent to a guidance provision determination step. The guidance provision determination unit 103 can determine whether occupant set route guidance is under way, for example, based on a result of determination of the behavior determination unit acquired from the automated driving ECU 17 by the information acquisition unit 101. In more detail, the guidance provision determination unit 103 can determine whether occupant set route guidance is under way based on information about whether the behavior determination unit has accepted an input of a destination from an occupant to determine a long and mid-term traveling plan. When an input of a destination has been accepted from an occupant to determine a long and mid-term traveling plan, the guidance provision determination unit 103 can determine that occupant set route guidance is under way. When a tentative destination has been set as destination to determine a long and mid-term traveling plan, the guidance provision determination unit 103 can determine that occupant set route guidance is not under way.

The repetition determination unit 104 determines whether the subject vehicle is traveling along a route along which the subject vehicle has repetitively traveled a predetermined number of times or more (hereafter, referred to as repetitive route) in the past. The repetition determination unit 104 determines whether the subject vehicle is traveling along a repetitive route based on the above-mentioned driving history acquired at the information acquisition unit 101 and a result of recognition at the travel environment recognition unit. When a subject vehicle position is located on a route (that is, repetitive route) along which the subject vehicle has traveled a predetermined number of times or more in the past, the repetition determination unit 104 can determine that the subject vehicle is traveling along a repetitive route. As the predetermined number of times cited here, any value can be set. A predetermined number of times may be more than once or may be once. A plurality of times are preferably set as a predetermined number of times so that a route along which a driver frequently drives can be accurately determined as repetitive route.

The timing determination unit 105 determines a predetermined timing providing a trigger for causing prompting notification described later. The timing determination unit 105 can determine a time when an elapsed time from start of automated driving free from a monitoring obligation reaches a predetermined timing (hereafter, referred to as time timing) as a predetermined timing. The timing determination unit 105 can determine a time to start automated driving free from a monitoring obligation from a result of determination successively made by the level determination unit 102. An elapsed time can be measured using a timer circuit or the like. A value that can be arbitrarily set can be taken as the specified time cited here.

The timing determination unit 105 may determine a time a mileage of the subject vehicle from start of automated driving free from a monitoring obligation reaches a specified mileage (hereafter, referred to as mileage timing) as a predetermined timing. A mileage can be determined from a vehicle speed pulse acquired from the vehicle speed sensor at the information acquisition unit 101. A value that can be arbitrarily set can be taken as the specified mileage cited here.

The timing determination unit 105 may determine a time when the subject vehicle arrives at a predetermined place (hereafter, referred to place timing) as a predetermined timing. A predetermined place may be a predetermined area or may be a predetermined spot. Examples of a predetermined place are interchange, tollgate, and the like.

The timing determination unit 105 may determine a time at predetermined timing intervals from start of automated driving free from a monitoring obligation (hereafter, referred to as by cycle timing) as a predetermined timing. A predetermined timing intervals can be arbitrarily set. A time interval at which notification is less prone to be irritating can be taken as a predetermined timing interval based on relation between notification frequency and irritation.

The notification control unit 100 controls notification by the notification device 18. When the guidance provision determination unit 103 determines that occupant set route guidance is not under way during automated driving free from a monitoring obligation of the subject vehicle, the notification control unit 100 causes prompting notification at a predetermined timing determined by the timing determination unit 105. This processing at the notification control unit 100 is equivalent to a notification control step. The notification control unit 100 can determine whether the subject vehicle is during automated driving free from a monitoring obligation from a result of determination of an automation level at the level determination unit 102. When an automation level determined at the level determination unit 102 is LV 2 or lower level, the notification control unit 100 can determine that the subject vehicle is during monitoring obligated automated driving. When an automation level determined at the level determination unit 102 is LV 3 or higher levels, the notification control unit 100 can determine that the subject vehicle is during automated driving free from a monitoring obligation.

The prompting notification is at least either confirmation notification prompting confirmation related to route setting or situation notification notifying of a traveling situation. Examples of the confirmation notification include setting prompting notification prompting setting of a destination and setting state notification indicating a present state of route setting. Examples of the setting prompting notification include a display of text of “Won't you set a destination?”, voice output, and the like. As a result of setting prompting notification being made, a driver can perceive that a destination is not set by an occupant. Then, the driver can confirm whether driving is being performed as intended and can set a destination if necessary and cause driving as intended.

Notification indicating that a destination is not set by an occupant of the subject vehicle can be taken as setting state notification. Notification indicating that automated driving free from a monitoring obligation is under way without a destination set by an occupant of the subject vehicle may be taken as setting state notification. Examples of setting state notification include a display of text of “LV 3 automated driving under way without route setting,” voice output, and the like. Also, as a result of setting state notification being made, a driver can perceive that a destination is not set by an occupant. Then, the driver can confirm whether driving is being performed as intended and can set a destination if necessary and cause driving as intended.

Notification indicating a present driving location, a traveling plan, or the like of the subject vehicle can be taken as situation notification. Examples of situation notification include a display of text of “Passing through interchange” or “Continuing to drive on highway,” voice output, and the like. As a result of situation notification being made, a driver can perceive whether driving is being performed as intended. Further, the driver can set a destination if necessary and cause driving as intended.

The notification control unit 100 may cause all of setting prompting notification, setting state notification, and situation notification or some thereof as prompting notification. When the subject vehicle is during automated driving free from a monitoring obligation, a driver may concentrate on a second task; therefore, prompting notification is preferably caused not only by a display in the display device 181 but also by voice output from the voice output device 182.

When causing prompting notification, the notification control unit 100 can sequentially cause a plurality of types of prompting notification, including at least two types of notification from among setting prompting notification, setting state notification, and situation notification. When causing prompting notification, the notification control unit 100 may be so configured as to cause any one type of setting prompting notification, setting state notification, and situation notification. Of the prompting notification, a display in the display device 181 may be so configured as to simultaneously cause a plurality of types of notification, including at least two types of setting prompting notification, setting state notification, and situation notification.

When the guidance provision determination unit 103 determines that occupant set route guidance is not under way during automated driving free from a monitoring obligation of the subject vehicle, the notification control unit 100 preferably causes, as situation notification, notification of information of a predetermined point through which the subject vehicle is planned to pass at the above-mentioned time by cycle timing. According to the foregoing, even when a plurality of predetermined points exist within a predetermined timing interval, information of the predetermined points need not be notified more than once. Therefore, irritation of notification can be suppressed as compared with a configuration in which notification is caused at each predetermined point. Examples of the predetermined points include, for example, a junction of roads and the like. The junction may be limited to a junction of highways.

Even in a case where the guidance provision determination unit 103 determines that occupant set route guidance is not under way during automated driving free from a monitoring obligation of the subject vehicle, when the repetition determination unit 104 determines that the subject vehicle is traveling along a repetitive route, the notification control unit 100 preferably prevents prompting notification from being caused at a predetermined timing determined by the timing determination unit 105. According to the foregoing, in a repetitively used route, such as a route used in commuting, irritation caused by prompting notification made each time the route is utilized can be suppressed.

To suppress useless processing, when the subject vehicle is during monitoring obligated driving or occupant set route guidance is under way, the timing determination unit 105 may be so configured as not to determine a predetermined timing. The timing determination unit 105 can determine whether the subject vehicle is during automated driving free from a monitoring obligation from a result of determination of an automation level at the level determination unit 102. The timing determination unit 105 can determine whether occupant set route guidance is under way from a result of determination at the guidance provision determination unit 103.

### <Notification Control Related Processing at HCU 10>

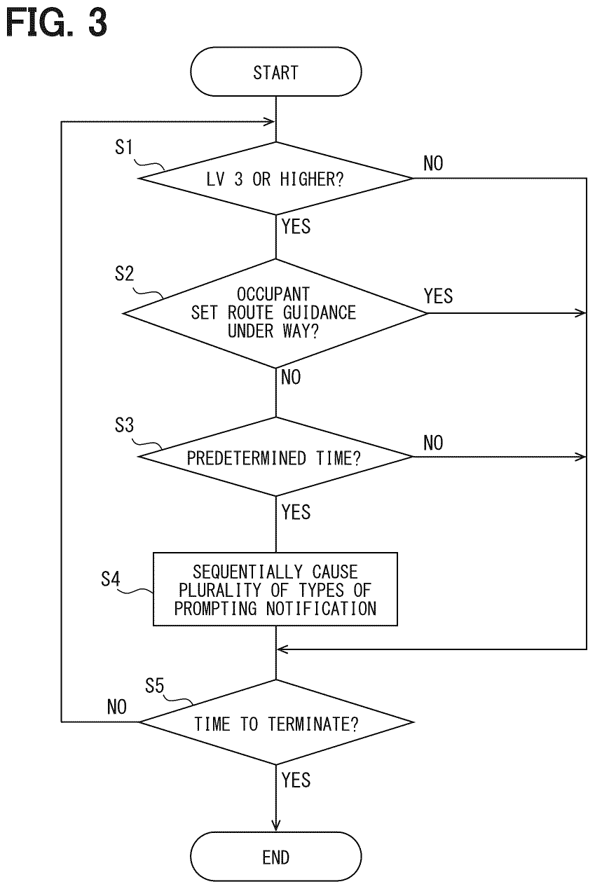

A description will be given to an example of a flow of processing related to control of prompting notification (hereafter, referred to as notification control related processing) at the HCU 10 with reference to the flowchart in FIG. 3. The flowchart in FIG. 3 can be so configured as to be started, for example, when a switch for starting an internal combustion engine or motor generator of the subject vehicle (hereafter, referred to as power switch) is turned on. Aside from the foregoing, when a configuration in which an automated driving function can be switched between on and off is adopted, the flowchart can be so configured that that the automated driving function is on is also added to a condition. In the description given here, a case where three types of notification, setting prompting notification, setting state notification, and situation notification, are caused as prompting notification will be taken as an example.

First, at Step S1, an automation level of the subject vehicle determined at the level determination unit 102 is LV 3 or higher levels (YES at S1), the processing proceeds to Step S2. Meanwhile, when an automation level of the subject vehicle is lower than LV 3 (NO at S1), the processing proceeds to Step S5.

At Step S2, the guidance provision determination unit 103 determines that occupant set route guidance is under way (YES at S2), the processing proceeds to Step S5. Meanwhile, when it is determined that occupant set route guidance is not under way (NO at S2), the processing proceeds to Step S3.

At Step S3, the timing determination unit 105 determines that a predetermined timing has come (YES at S3), the processing proceeds to Step S4. Meanwhile, when it is not determined that a predetermined timing has come (NO at S3), the processing proceeds to Step S5.

The timing determination unit 105 can determine only any one of time timing, mileage timing, and place timing as a predetermined timing. For example, the timing determination unit 105 can determine only a timing, among time timing, mileage timing, and place timing, that meets a condition first since start of automated driving free from a monitoring obligation as a predetermined timing. According to the foregoing, frequent repetition of prompting notification is suppressed and irritation can be suppressed.

The timing determination unit 105 may determine more than one of time timing, mileage timing, and place timing as a predetermined timing. In this case, the present disclosure may be so configured that prompting notification is caused each time a different type of timing is given. With respect to time timing and mileage timing, the timing determination unit 105 may be so configured as to use only either thereof as a predetermined timing. According to the foregoing, since prompting notification is caused each time a condition for a predetermined timing of a different type is met, the prompting notification can be made easily perceived.

At Step S4, the notification control unit 100 sequentially causes a plurality of types of prompting notification, setting prompting notification, setting state notification, and situation notification. At Step S5, it is time to terminate the notification control related processing (YES at S5), the notification control related processing is terminated. Meanwhile, when it is not time to terminate the notification control related processing (NO at S5), the processing returns to S1 and is repeated. Examples of time to terminate notification control related processing include that the power switch is turned off, that the automated driving function is turned off, and the like.

According to the configuration of the first embodiment, when route guidance set by an occupant of the subject vehicle is not provided during automated driving free from a monitoring obligation, at a predetermined timing, prompting notification, which is either of confirmation notification prompting confirmation related to setting of a route and situation notification notifying of a driving situation, is made.

When confirmation notification prompting confirmation related to setting of a route or situation notification notifying of a traveling situation is made, the notification provides a trigger for a driver to confirm whether driving different from the driver's intention is not being performed. Therefore, when a driver can perceive that the driver is performing driving different from the driver's intention by causing prompting notification, the driver can change the driving to a driving along a route corresponding to the driver's intention. As a result, degradation in convenience can be suppressed during automated driving free from a monitoring obligation.

### (Second Embodiment)

In relation to the first embodiment, a configuration in which as prompting notification, a plurality of types of notification from among setting prompting notification, setting state notification, and situation notification can be made has been described but the present disclosure need not be configured as mentioned above.

For example, the present disclosure may be so configured that the notification control unit 100 can cause only one type of notification from among setting prompting notification, setting state notification, and situation notification.

### (Third Embodiment)

The present disclosure need not be configured as in the first embodiment and may be configured as in the third embodiment described below. Hereafter, a description will be given to an example of the third embodiment with reference to drawings. The vehicular system 1 in the third embodiment is identical with the vehicular system 1 in the first embodiment except that HCU 10a is included in place of the HCU 10.

<General Configuration of HCU 10a>

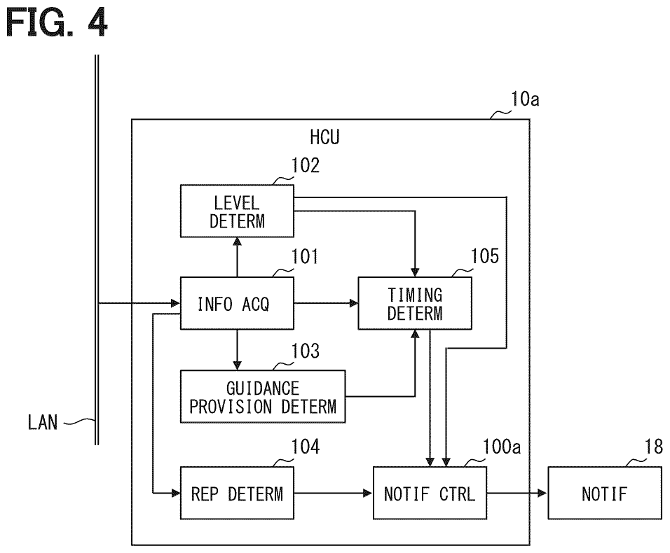

A description will be given to a general configuration of the HCU 10a with reference to FIG. 4. With respect to notification control at the notification device 18, as shown in FIG. 4, the HCU 10a includes, as functional blocks, a notification control unit 100a, the information acquisition unit 101, the level determination unit 102, the guidance provision determination unit 103, the repetition determination unit 104, and timing determination unit 105. The HCU 10a is identical with the HCU 10 in the first embodiment except that the notification control unit 100a is provided in place of the notification control unit 100. The HCU 10a is also equivalent to the control device for a vehicle. Execution of processing of each functional block of the HCU 10a by the computer is also equivalent to execution of the control method for a vehicle.

The notification control unit 100a is identical with the notification control unit 100 in the first embodiment except that some processing is different. This processing at the notification control unit 100a is also equivalent to a notification control step. Hereafter, a description will be given to processing of the notification control unit 100a different from processing of the notification control unit 100. The notification control unit 100a causes setting prompting notification as prompting notification. With respect to the notification control unit 100a, setting state notification or situation notification is not included in prompting notification that is on condition of a predetermined timing.

When the guidance provision determination unit 103 determines that route guidance is not under way during automated driving free from a monitoring obligation of the subject vehicle, the notification control unit 100a causes at least either setting state notification or situation notification (hereafter, referred to as non-set time normal notification) from before a predetermined timing determined by the timing determination unit 105. Meanwhile, when the guidance provision determination unit 103 determines that route guidance is not under way during automated driving free from a monitoring obligation of the subject vehicle, the notification control unit 100a causes setting prompting notification at a predetermined timing determined by the timing determination unit 105. Non-set time normal notification is not preferably caused by voice output from the voice output device 182 but is preferably caused by such the display device 181 as the meter MID. According to the foregoing, a driver who has turned the driver's eyes to the display device 181 from before a predetermined timing can easily confirm whether driving is being performed as intended. By causing setting prompting notification at a predetermined timing, a driver who does not perceive non-set time normal notification can also be more reliably made to perceive that a destination has not been set by an occupant. According to the foregoing, a driver can be more reliably made to confirm whether driving is being performed as intended.

<Notification Control Related Processing at HCU 10a>

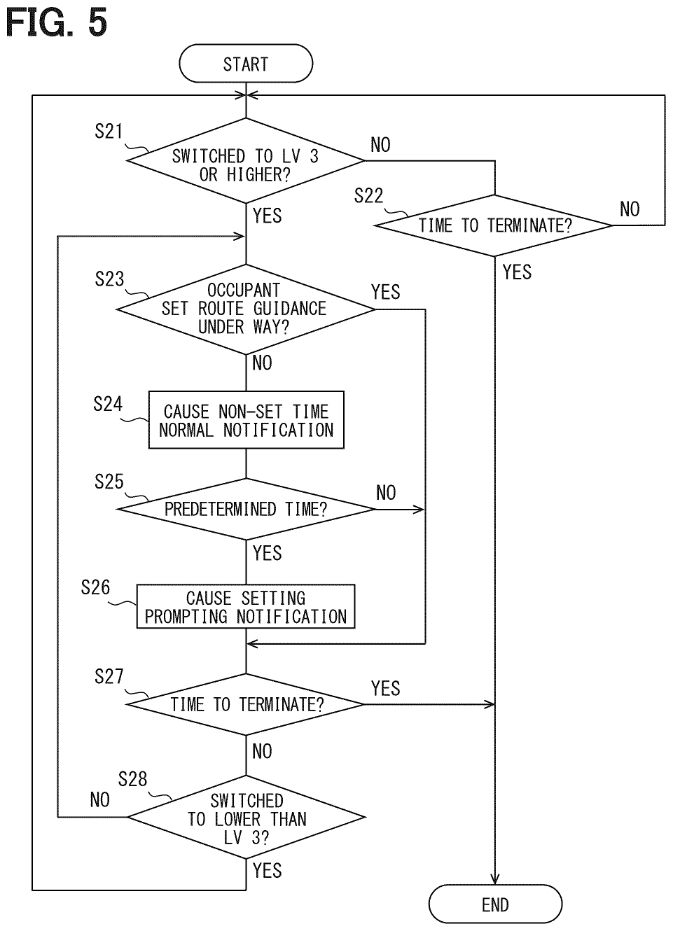

Subsequently, a description will be given to an example of a flow of notification control related processing at the HCU 10a with reference to the flowchart in FIG. 5. The flowchart in FIG. 5 can also be so configured as to be started, for example, when the power switched is turned on. Aside from the foregoing, when a configuration in which an automated driving function can be switched between on and off is adopted, the flowchart can be so configured that that the automated driving function is on is also added to a condition.

First, at Step S21, an automation level of the subject vehicle determined at the level determination unit 102 is switched from lower than LV 3 to LV 3 or high levels (YES at S21), the processing proceeds to Step S23. Meanwhile, when an automation level of the subject vehicle is lower than LV 3 (NO at S21), the processing proceeds to Step S22. Whether an automation level of the subject vehicle has been switched from lower than LV 3 to LV 3 or higher levels can be determined by the notification control unit 100a successively monitoring an automation level of the subject vehicle determined at the level determination unit 102.

At Step S22, it is time to terminate the notification control related processing (YES at S22), the notification control related processing is terminated. Meanwhile, when it is not time to terminate the notification control related processing (NO at S22), the processing returns to S21 and is repeated.

At Step S23, the guidance provision determination unit 103 determines that occupant set route guidance is under way (YES at S23), the processing proceeds to Step S27. Meanwhile, when it is determined that occupant set route guidance is not under way (NO at S23), the processing proceeds to Step S24.

At Step S24, the notification control unit 100a causes non-set time normal notification. The non-set time normal notification may be only either setting state notification or situation notification. The notification control unit 100a can continue non-set time normal notification by display in the display device 181 until the guidance provision determination unit 103 determines that occupant set route guidance is under way. In this case, icon display or the like may be adopted as non-set time normal notification.

At Step S25, the timing determination unit 105 determines that it is a predetermined timing (YES at S25), the processing proceeds to Step S26.

Meanwhile, when it is not determined that it is a predetermined timing (NO at S25), the processing proceeds to Step S27. The determination of a predetermined timing at S25 can be performed as the determination of a predetermined timing at S3.

As Step S26, the notification control unit 100 causes setting prompting notification. Unlike non-set time normal notification, setting prompting notification is preferably made at least by voice output from the voice output device 182. For example, setting prompting notification is preferably caused by voice output from the voice output device 182 in addition to display in the display device 181.

At Step S27, it is time to terminate the notification control related processing (YES at S27), the notification control related processing is terminated. Meanwhile, when it is not time to terminate the notification control related processing (NO at S27), the processing proceeds to Step S28.

At Step S28, an automation level of the subject vehicle determined at the level determination unit 102 is switched from LV 3 or higher levels to lower than LV 3 (YES at S28), the processing returns to Step S21 and is repeated. Meanwhile, when an automation level of the subject vehicle is LV 3 or higher level (NO at S28), the processing is returned to Step S23 and is repeated. Whether an automation level of the subject vehicle is switched from LV 3 or higher levels to lower than LV 3 can determined by the notification control unit 100a successively monitoring an automation level of the subject vehicle determined at the level determination unit 102.

Even with the configuration of the third embodiment, when route guidance set by an occupant of the subject vehicle is not provided during automated driving free from a monitoring obligation, setting prompting notification is made to prompt setting of a destination at a predetermined timing. When setting prompting notification is made to prompt setting of a destination, a driver can perceive that a destination is not set by an occupant. Then, the driver can confirm whether driving is being performed as intended and can set a destination if necessary and cause driving as intended. As a result, degradation in convenience can be suppressed during automated driving free from a monitoring obligation.

### (Fourth Embodiment)

In relation to the above-mentioned embodiments, a configuration in which the timing determination unit 105 can determine a plurality of types of timing from among time timing, mileage timing, and place timing as a predetermined timing but the present disclosure need not be configured as mentioned above. For example, the present disclosure may be so configured that the timing determination unit 105 can determine only one type of timing from among time timing, mileage timing, and place timing as a predetermined timing.

### (Fifth Embodiment)

The present disclosure need not be configured as in the first embodiment and may be configured as in the fifth embodiment described below. Hereafter, a description will be given to an example of the fifth embodiment with reference to drawings. The vehicular system 1 in the fifth embodiment is identical with the vehicular system 1 in the first embodiment except that HCU 10b is included in place of the HCU 10.

<General Configuration of HCU 1b>

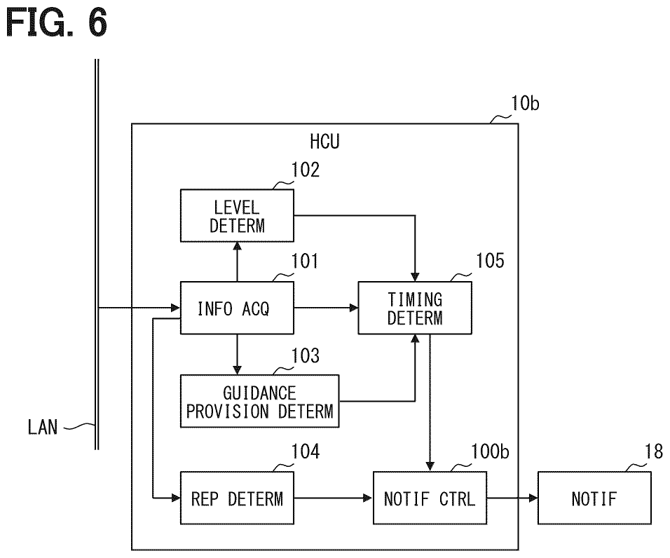

A description will be given to a general configuration of the HCU 10b with reference to FIG. 6. With respect to control of notification at the notification device 18, as shown in FIG. 6, the HCU 10b includes, as functional blocks, a notification control unit 100b, the information acquisition unit 101, the level determination unit 102, the guidance provision determination unit 103, the repetition determination unit 104, and the timing determination unit 105. The HCU 10b is identical with the HCU 10 in the first embodiment except that the notification control unit 100b is provided in place of the notification control unit 100. The HCU 10b is also equivalent to the control device for a vehicle. Further, execution of the processing of each functional block of the HCU 10b by the computer is also equivalent to execution of the control method for a vehicle.

The notification control unit 100b is identical with the notification control unit 100 in the first embodiment except that a type or a combination of types of prompting notification is changed according to a type of a predetermined timing. This processing at the notification control unit 100b is also equivalent to a notification control step. When the guidance provision determination unit 103 determines that route guidance is not under way during automated driving free from a monitoring obligation of the subject vehicle, the notification control unit 100b causes at least any of setting prompting notification, setting state notification, and situation notification as prompting notification by at least two types of timing from among time timing, mileage timing, and place timing determined at the timing determination unit 105. Further, the notification control unit 100b changes a type or a combination of types of prompting notification according to at which type of predetermined timing prompting notification should be caused. Which type or combination of types of prompting notification should be caused at which type of a predetermined timing can be arbitrarily set.

According to the foregoing, a type or a combination of types of prompting notification can be caused in accordance with a type of a predetermined timing that is a condition for prompting notification.

<Notification Control Related Processing at HCU 10b>

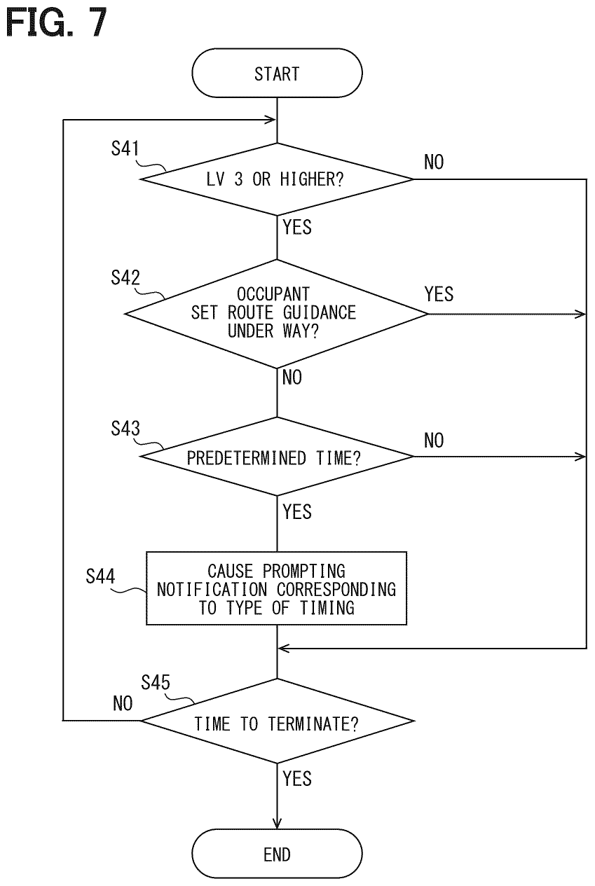

Subsequently, a description will be given to an example of a flow of notification control related processing at the HCU 10b with reference to the flowchart in FIG. 7. The flowchart in FIG. 7 can also be so configured as to be started, for example, when the power switch is turned on. Aside from the foregoing, when a configuration in which an automated driving function can be switched between on and off is adopted, the flowchart can be so configured that that the automated driving function is on is also added to a condition.

First, at Step S41, an automation level of the subject vehicle determined at the level determination unit 102 is LV 3 or higher levels (YES at S41), the processing proceeds to Step S42. Meanwhile, when an automation level of the subject vehicle is lower than LV 3, (NO at S41), the processing proceeds to Step S45.

At Step S42, the guidance provision determination unit 103 determines that occupant set route guidance is under way (YES at S42), the processing proceeds to Step S45. Meanwhile, when it is determined that occupant set route guidance is not under way (NO at S42), the processing proceeds to Step S43.

At Step S43, the timing determination unit 105 determines that it is a predetermined timing (YES at S43), the processing proceeds to Step S44. Meanwhile, when it is not determined that it is a predetermined timing (NO at S43), the processing proceeds to Step S45.

The timing determination unit 105 can determine at least two types of timing from among time timing, mileage timing, and place timing as a predetermined timing. With respect to time timing and mileage timing, the timing determination unit 105 may be so configured as to use only either thereof as a predetermined timing.

At Step S44, the notification control unit 100 causes prompting notification of a type or a combination of types corresponding to a predetermined timing determined at S43, the nearest step. At least two types from among time timing, mileage timing, and place timing are taken as types of a predetermined timing. At least two types from among setting prompting notification, setting state notification, and situation notification are taken as types of prompting notification.

At Step S45, it is time to terminate the notification control related processing (YES at S45), the notification control related processing is terminated. Meanwhile, when it is not time to terminate the notification control related processing (NO at S45), the processing returns to S41 and is repeated.

Even with the configuration of the fifth embodiment, when route guidance set by an occupant of the subject vehicle is not under way during automated driving free from a monitoring obligation, at least any prompting notification from among setting prompting notification, setting state notification, and situation notification is made. Therefore, degradation in convenience can be suppressed at a time of automated driving free from a monitoring obligation.

### (Sixth Embodiment)

The present disclosure need not be configured as in the above-mentioned embodiments and may be configured as in the sixth embodiment described below.

Hereafter, a description will be given to an example of a configuration of the sixth embodiment with reference to drawings.

<General Configuration of Vehicular System 1c>

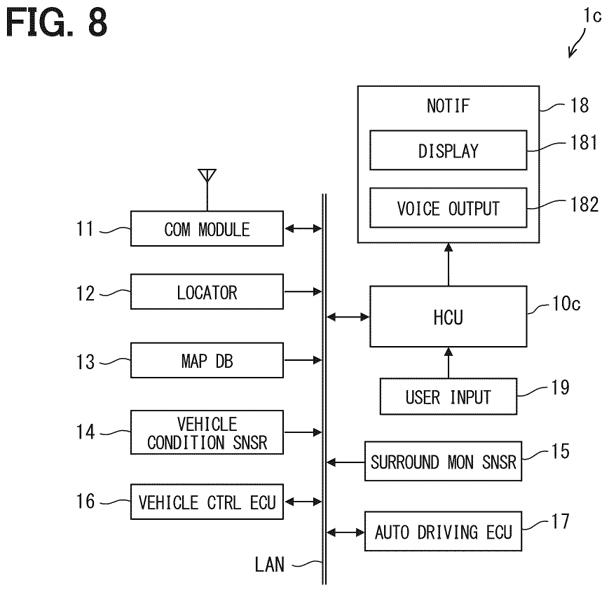

The vehicular system 1c shown in FIG. 8 can be used in an automated driving vehicle. As shown in FIG. 8, the vehicular system 1c includes: the HCU 10c, the communication module 11, the locator 12, the map DB 13, the vehicle condition sensor 14, the surround monitoring sensor 15, the vehicle control ECU 16, the automated driving ECU 17, the notification device 18, and the user input device 19. The vehicular system 1c in the sixth embodiment is identical with the vehicular system 1 in the first embodiment except that HCU 10c is included in place of the HCU 10.

The automated driving ECU 17 in the sixth embodiment preferably performs reroute to search for a recommended route again. When input of a destination is newly accepted from an occupant, reroute can be performed at the behavior determination unit. In this case, a route from a subject vehicle position to the destination newly inputted and accepted can be searched for again. When the subject vehicle departs from a recommended route that has been already searched for, for some reason, reroute may be performed at the behavior determination unit. In this case, a route from a subject vehicle position to an already set destination can be searched for.

Hereafter, a state of the subject vehicle during automated driving free from a monitoring obligation with a destination set by an occupant of the subject vehicle will be referred to as a mode A or a first mode. Hereafter, a state of the subject vehicle during automated driving free from a monitoring obligation without a destination set by an occupant of the subject vehicle will be referred to as a mode B or a second mode. Hereafter, a state of the subject vehicle during automated driving free from a monitoring obligation, different from mode A and mode B, that occurs when reroute takes place will be referred to as a mode C or a third mode. Mode C may be limited to a case where reroute takes place in mode A.

<General Configuration of HCU 10c>

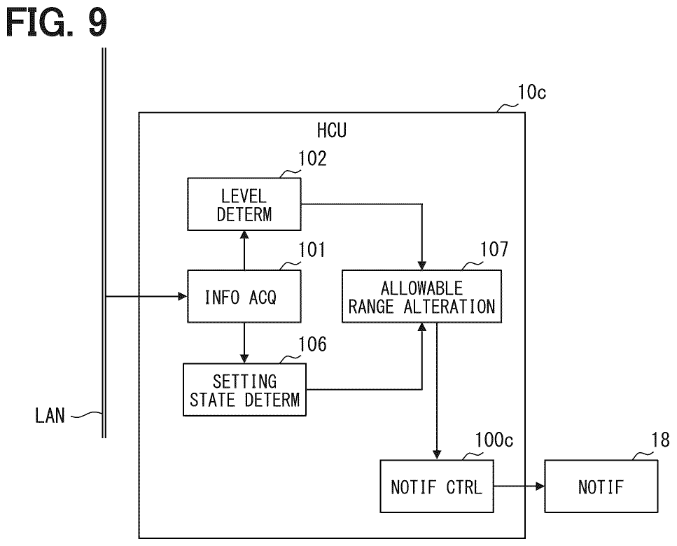

A description will be given to a general configuration of the HCU 10c with reference to FIG. 9. With respect to control of notification at the notification device 18, as shown in FIG. 9, the HCU 10c includes, as functional blocks, a notification control unit 100c, the information acquisition unit 101, the level determination unit 102, a setting state determination unit 106, and an allowable range alteration unit 107. The HCU 10c includes the notification control unit 100c in place of the notification control unit 100. The HCU 10c includes the setting state determination unit 106 and the allowable range alteration unit 107. The HCU 10c is identical with the HCU 10 in the first embodiment except these respects. The HCU 10c is also equivalent to the control device for a vehicle. Further, execution of the processing of each functional block of the HCU 10c by the computer is also equivalent to the control method for a vehicle.

The setting state determination unit 106 determines a setting state that is a state related to setting of a destination of the subject vehicle. The processing at the setting state determination unit 106 is equivalent to a setting state determination step. The setting state determination unit 106 determines whether a destination has been set by an occupant of the subject vehicle as a setting state. The setting state determination unit 106 can determine whether a destination has been set by an occupant of the subject vehicle based on a result of determination at the behavior determination unit. What is acquired from the automated driving ECU 17 by the information acquisition unit 101 can be used as a result of determination at the behavior determination unit. As this determination result, information about whether input of a destination has been accepted from an occupant at the behavior determination unit and a long and mid-term traveling plan has been determined can be used. When input of a destination has been accepted from an occupant and a long and mid-term traveling plan has been determined, the setting state determination unit 106 can determine that a destination has been set by an occupant of the subject vehicle. When a long and mid-term traveling plan has been determined with a tentative destination set as destination, the setting state determination unit 106 can determine that a destination has not been set by an occupant of the subject vehicle.

The setting state determination unit 106 preferably determines whether reroute has taken place as a setting state. The setting state determination unit 106 can determine whether reroute has taken place based on a result of determination at the behavior determination unit. What is acquired from the automated driving ECU 17 by the information acquisition unit 101 can be used as a result of determination at the behavior determination unit. As this determination result, information about whether reroute has been performed at the behavior determination unit can be used. When reroute has been performed at the behavior determination unit, the setting state determination unit 106 can determine that reroute has taken place. When reroute has not been performed at the behavior determination unit, the setting state determination unit 106 can determine that reroute has not taken place. The setting state determination unit 106 preferably determines whether reroute has been completed as a setting state. The setting state determination unit 106 can determine whether reroute has been completed based on a result of determination at the behavior determination unit. Completion of search for a new recommended route by reroute can be taken as completion of reroute.

The allowable range alteration unit 107 alters an allowable range of second tasks in mode A and in mode B based on a setting state determined at the setting state determination unit 106. This processing at the allowable range alteration unit 107 is equivalent to an allowable range alteration step. The allowable range alteration unit 107 can determine whether the subject vehicle is in mode A or in mode B from an automation level determined at the level determination unit 102 and the above-mentioned setting state. The allowable range alteration unit 107 can issue an instruction to the notification control unit 100c to alter an allowable range of second tasks. Mode A is a state of the subject vehicle during automated driving free from a monitoring obligation with a destination set by an occupant of the subject vehicle. Mode B is a state of the subject vehicle during automated driving free from a monitoring obligation without a destination set by an occupant of the subject vehicle. In mode B, the allowable range alteration unit 107 narrows an allowable range of second tasks as compared with in mode A. For example, while display of contents involving a long viewing time can be permitted in mode A, display of contents involving a long viewing time can be prohibited in mode B. Examples of contents involving a long viewing time are movie and the like.

In mode B, a destination has not been set by an occupant of the subject vehicle and it is difficult to determine a driver's desired traveling route. Therefore, when the subject vehicle departs from a driver's desired traveling route, it is preferable that the driver can swiftly correct the route by override. According to the above-mentioned configuration, an allowable range of second tasks is narrowed; therefore, a driver can be made less prone to be absorbed in a second task. Therefore, even when the subject vehicle departs from a driver's desired traveling route, the driver can easily and swiftly correct the route by override. As a result, degradation in convenience can be suppressed during automated driving free from a monitoring obligation.

As another example of narrowing an allowable range of second tasks, the following procedure may be taken. For example, when prohibited second tasks are displayed in the display device 181, a number of items displayed as prohibited second tasks may be increased. When an automation level determined at the level determination unit 102 is level 2 or lower level, the allowable range alteration unit 107 can be so configured as not to permit execution of a second task.

In mode C, the allowable range alteration unit 107 preferably narrows an allowable range of second tasks as compared with in mode A and in mode B. The allowable range alteration unit 107 can determine that the subject vehicle is in mode C from a result of determination of whether reroute has taken place and an automation level determined at the level determination unit 102. In mode C, the allowable range alteration unit 107 preferably prevents execution of a second task from being permitted. In mode C in which reroute has occurred, a route is being searched for; therefore, override by a driver is high probably required more than in mode A and in mode B. According to the above-mentioned configuration, in mode C, an allowable range of second tasks is narrowed as compared with in mode A and in mode B; therefore, a driver can be made less prone to be absorbed in a second task. Therefore, in a situation in which override by a driver is more required, a driver can more easily and swiftly perform override. Examples of prevention of execution of a second task include prohibition of display from the notification device 18 and voice output equivalent to the second task. Another example is that when a prohibited second task is displayed in the display device 181, a display indicating prohibition of all the types of second tasks is provided.

The notification control unit 100c controls notification at the notification device 18. The notification control unit 100c alters an allowable range of second tasks in accordance with an instruction from the allowable range alteration unit 107.

<Second Task Limitation Related Processing at HCU 10c>

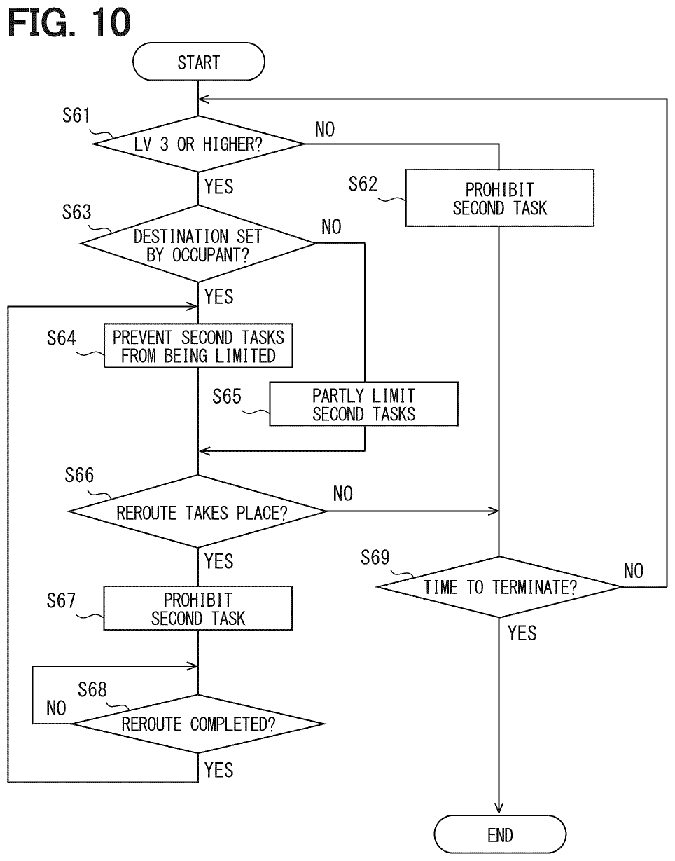

A description will be given to an example of a flow of processing related to limitation of second tasks at the HCU 10c (hereafter, referred to as second task limitation related processing) with reference to the flowchart in FIG. 10. The flowchart in FIG. 10 can be so configured as to be started, for example, when the power switch is turned on. Aside from the foregoing, when a configuration in which an automated driving function can be switched between on and off is adopted, the flowchart can be so configured that that the automated driving function is on is also added to a condition.

First, at Step S61, an automation level of the subject vehicle determined at the level determination unit 102 is LV 3 or higher levels (YES at S61), the processing proceeds to Step S63. Meanwhile, when an automation level of the subject vehicle is lower than LV 3 (NO at S61), the processing proceeds to Step S62. At step S62, the allowable range alteration unit 107 prevents execution of a second task from being permitted and the processing proceeds to Step S69. That is, the second task is prohibited and the processing proceeds to S69.

At Step S63, the setting state determination unit 106 determines that a destination has been set by an occupant of the subject vehicle (YES at S63), the processing proceeds to Step S64. Meanwhile, when the setting state determination unit 106 determines that a destination has not been set by an occupant of the subject vehicle (NO at S63), the processing proceeds to Step S65.

At Step S64, the allowable range alteration unit 107 prevents second tasks from being limited and the processing proceeds to Step S66. Preventing second tasks from being limited means that all the types of second tasks targeted in the subject vehicle are permitted. At Step S65, the allowable range alteration unit 107 limits some of second tasks and the processing proceeds to Step S66. For example, viewing of movie contents can be prohibited.

At Step S66, the setting state determination unit 106 determines that reroute has taken place (YES at S66), the processing proceeds to Step S67. Meanwhile, when the setting state determination unit 106 determines that reroute has not taken place (NO at S66), the processing proceeds to Step S69.

At Step S67, the allowable range alteration unit 107 prevent execution of a second task from being permitted and the processing proceeds to Step S68. At Step S68, the setting state determination unit 106 determines that reroute has been completed (YES at S68), the processing proceeds to S64 and is repeated. Meanwhile, when the setting state determination unit 106 determines that reroute has not been completed (NO at S68), the processing of S68 is repeated.

At Step S69, it is time to terminate the second task limitation related processing (YES at S69), the second task limitation related processing is terminated. Meanwhile, when it is not time to terminate the second task limitation related processing (NO at S69), the processing returns to S61 and is repeated. Examples of time to terminate second task limitation related processing includes that the power switch is turned off, that the automated driving function is turned off, and the like.

### (Seventh Embodiment)

The present disclosure need not be configured as in the above-mentioned embodiments and may be configured as in the seventh embodiment described below. Hereafter, a description will be given to an example of a configuration of the seventh embodiment with reference to the drawings.

<General Configuration of Vehicular System 1d>

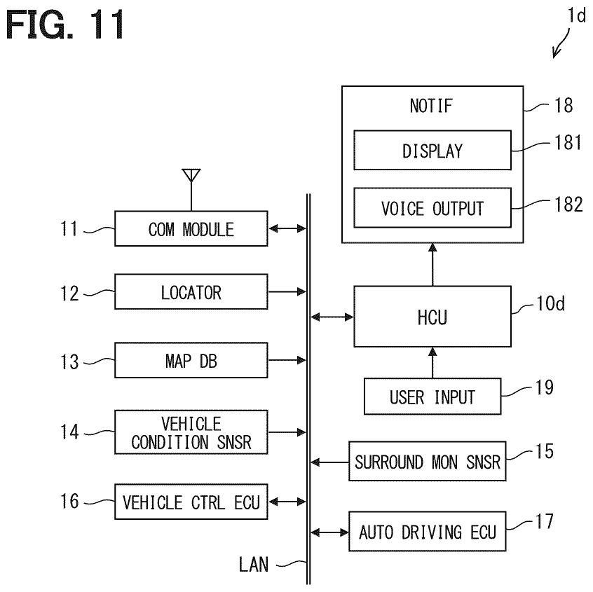

The vehicular system 1d shown in FIG. 11 can be used in an automated driving vehicle. As shown in FIG. 11, the vehicular system 1d includes: the HCU 10d, the communication module 11, the locator 12, the map DB 13, the vehicle condition sensor 14, the surround monitoring sensor 15, the vehicle control ECU 16, the automated driving ECU 17, the notification device 18, and the user input device 19. The vehicular system 1d in the seventh embodiment is identical with the vehicular system 1c in the sixth embodiment except that HCU 10d is included in place of the HCU 10c.

When input of a destination has not been accepted from an occupant, the behavior determination unit of the automated driving ECU 17 generates a route for making the subject vehicle go to a tentative destination. In this case, a route in which traveling along the road takes priority over right and left turning is generated. That is, a route along which the subject vehicle travels by automated driving involves more going-straight sections in mode B than in mode A.

<General Configuration of HCU 10d>

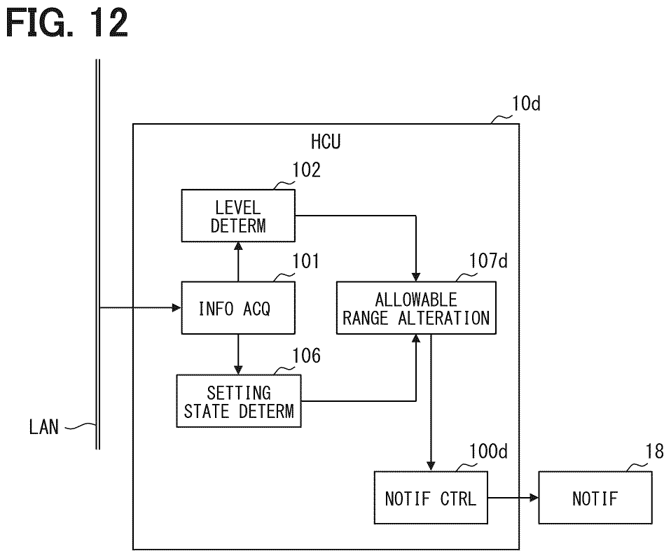

A description will be given to a general configuration of the HCU 10d with reference to FIG. 12. With respect to control of notification at the notification device 18, as shown in FIG. 12, the HCU 10d includes, as functional blocks, a notification control unit 100d, the information acquisition unit 101, the level determination unit 102, the setting state determination unit 106, and an allowable range alteration unit 107d. The HCU 10d includes the notification control unit 100d in place of the notification control unit 100c. The HCU 10d includes the allowable range alteration unit 107d in place of the allowable range alteration unit 107. The HCU 10d is identical with the HCU 10c in the sixth embodiment except these respects. The HCU 10d is also equivalent to the control device for a vehicle. Execution of the processing of each functional block of the HCU 10d by the computer is also equivalent to execution of the control method for a vehicle.

The notification control unit 100d is identical with the notification control unit 100c in the sixth embodiment except that an allowable range of second tasks is altered in accordance with an instruction from the allowable range alteration unit 107d. The allowable range alteration unit 107d is identical with the allowable range alteration unit 107 in the sixth embodiment except that some processing is different. This processing at the allowable range alteration unit 107d is also equivalent to an allowable range alteration step. Hereafter, a description will be given to a difference from the allowable range alteration unit 107 in the sixth embodiment. In mode B, the allowable range alteration unit 107d widens an allowable range of second tasks as compared with in mode A. In other words, in mode A, the allowable range alteration unit 107d narrows an allowable range of second tasks as compared with in mode B.

For example, while display of contents involving a long viewing time can be permitted in mode B, display of contents involving a long viewing time can be prohibited in mode A. Examples of contents involving a long viewing time are movie and the like. As another example of widening an allowable range of second tasks, the following procedure may be taken. For example, when prohibited second tasks are displayed in the display device 181, a number of items displayed as prohibited second tasks may be reduced.

In mode B, as mentioned above, it is guessed that a route along which the subject vehicle travels by automated driving involves more going-straight sections as compared with in mode A. Therefore, the behavior of the subject vehicle is highly probably stabilized as compared with in mode A and a second task can be easily enjoyed. According to the above-mentioned configuration, in a situation in which a second task can be easily enjoyed, an allowable range of second tasks is widened; therefore, a driver can more easily enjoy a second task. As a result, degradation in convenience can be suppressed during automated driving free from a monitoring obligation.

### (Eighth Embodiment)

The present disclosure need not be configured as in the above-mentioned embodiments and may be configured as in the eighth embodiment described below. Hereafter, a description will be given to an example of a configuration of the eighth embodiment with reference to the drawings.

<General Configuration of Vehicular System 1e>

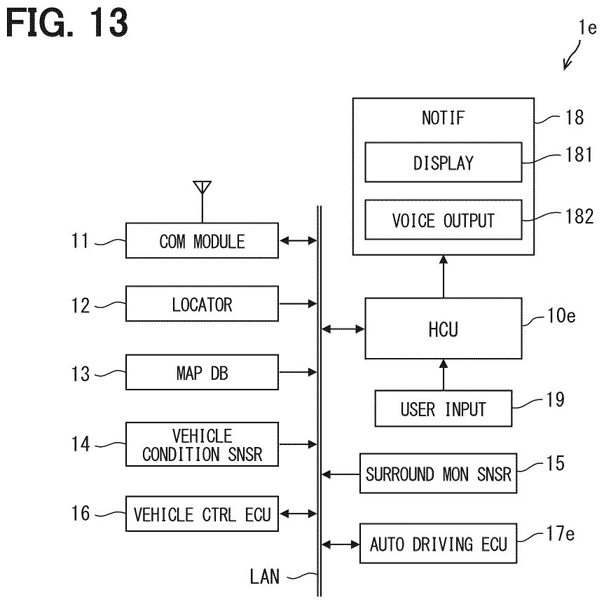

The vehicular system 1e shown in FIG. 13 can be used in an automated driving vehicle. As shown in FIG. 13, the vehicular system 1e includes: the HCU 10e, the communication module 11, the locator 12, the map DB 13, the vehicle condition sensor 14, the surround monitoring sensor 15, the vehicle control ECU 16, the automated driving ECU 17e, the notification device 18, and the user input device 19. The vehicular system 1e in the eighth embodiment includes the HCU 10e in place of the HCU 10. The vehicular system 1e in the eighth embodiment includes the automated driving ECU 17e in place of the automated driving ECU 17. The vehicular system 1e in the eighth embodiment is identical with the vehicular system 1 in the first embodiment except these respects.

The HCU 10e is identical with the HCU 10 in the first embodiment except that notification is made in accordance with an instruction from the automated driving ECU 17e. The HCU 10e may be so configured as not to perform the notification control related processing described in relation to the first embodiment.

<General Configuration of Automated Driving ECU 17e>

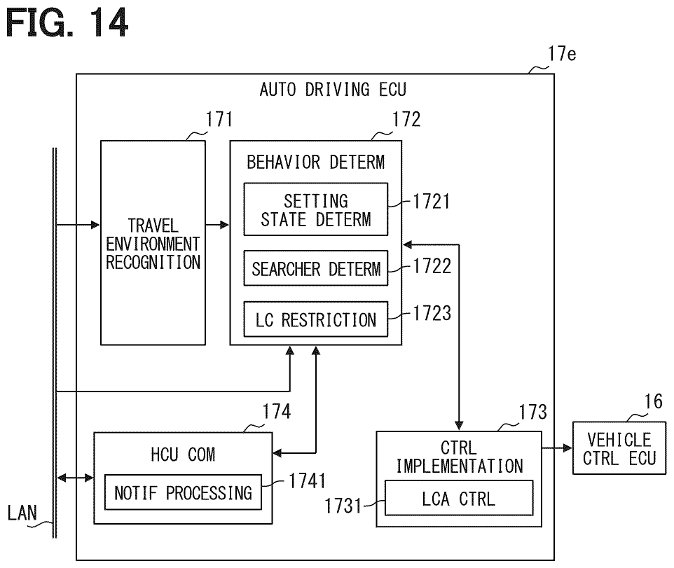

A description will be given to a general configuration of the automated driving ECU 17e with reference to FIG. 14. As shown in FIG. 14, the automated driving ECU 17e includes, as functional blocks, a travel environment recognition unit 171, a behavior determination unit 172, a control implementation unit 173, and an HCU communication unit 174. The automated driving ECU 17e is identical with the automated driving ECU 17 in the first embodiment except that some processing is different. The automated driving ECU 17e is also equivalent to the control device for a vehicle. Execution of processing of each functional block of the automated driving ECU 17e by the computer is also equivalent to execution of the control method for a vehicle. Part or all of the functions executed by the automated driving ECU 17e may be configured by hardware using one or more ICs or the like. Part or all of the functional blocks provided in the automated driving ECU 17e may be implemented by a combination of execution of software by the processor and a hardware member.

The travel environment recognition unit 171 is identical with the travel environment recognition unit described in relation to the first embodiment. The behavior determination unit 172 is identical with the behavior determination unit described in relation to the first embodiment except that some processing is different. A difference of the behavior determination unit 172 from the behavior determination unit in the first embodiment will be described later.

The control implementation unit 173 is identical with the control implementation unit described in relation to the first embodiment except that some processing is different. A difference of the control implementation unit 173 from the control implementation unit described in relation to the first embodiment is as described below. The control implementation unit 173 includes an LCA control unit 1731 as a sub-functional block. Though with respect to the present embodiment, a description is omitted for the sake of convenience, the control implementation unit 173 may exercise other driving control, such as ACC control and LTA control, than LCA control. To start a lane change in LCA control, LTA control can be tentatively interrupted so that departure from the subject vehicle's lane is feasible. Then, after completion of the lane change, LTA control can be resumed.

The LCA control unit 1731 automatically causes a lane change. The LCA control unit 1731 exercises LCA control to cause the subject vehicle to make an automatic lane change from a driving lane of the subject vehicle (hereafter, referred to as subject vehicle's lane) to an adjacent lane. In LCA control, a planned traveling path in such a shape that a target position of the present lane and the center of an adjacent lane are smoothly connected with each other is generated based on a result of recognition of a travel environment by the travel environment recognition unit 171. Then, a steering angle of the steering wheel of the subject vehicle is automatically controlled according to the planned traveling path and a lane change is thereby made from the present lane to the adjacent lane. For example, automatic lane change is made after the driving position in the subject vehicle's lane is brought close to an end of the subject vehicle's lane on the side to which the subject vehicle is caused to make a lane change (hereafter, referred to as LC-side end). Processing at a during-standby driving control unit 132, a canceling portion 133, and a canceling time driving control unit 134 will be described later.

The control implementation unit 173 restricts an automatic lane change at the LCA control unit 1731 in accordance with a result of determination at the behavior determination unit 172. To restrict an automatic lane change, when the automatic lane change has not been started, the automatic lane change can be prohibited. To restrict an automatic lane change, when the automatic lane change is under way, the automatic lane change may be aborted or the automatic lane change may be waited for. To abort an automatic lane change, LCA control can be canceled and LTA control can be resumed. To wait for an automatic lane change, driving can be maintained with the traveling position of the subject vehicle brought close to the LC-side end of the subject vehicle's lane without straddling a lane.

The HCU communication unit 174 performs processing of outputting information to the HCU 10e and processing of acquiring information from the HCU 10e. The HCU communication unit 174 acquires information of input accepted at the user input device 19 and the like. A notification processing unit 1741 is provided as a sub-functional block. The notification processing unit 1741 indirectly controls notification at the notification device 18 by sending an instruction to the HCU 10e. The notification processing unit 1741 is equivalent to a notification instruction unit.

The behavior determination unit 172 preferably performs reroute to search for a recommended route again. Reroute can be performed when input of a destination is newly accepted from an occupant. In this case, a route from a subject vehicle position to the destination newly inputted and accepted can be searched for again. Reroute may be performed when the subject vehicle departs from a recommended route already searched for, for some reason. In this case, a route from a subject vehicle position to an already set destination can be searched for.

As in the above-mentioned embodiments, a state of the subject vehicle during automated driving free from a monitoring obligation with a destination set by an occupant of the subject vehicle will be referred to as mode A. A state of the subject vehicle during automated driving free from a monitoring obligation without a destination set by an occupant of the subject vehicle will be referred to as mode B. A state of the subject vehicle during automated driving free from a monitoring obligation, different from mode A and mode B, that occurs when reroute takes place will be referred to as mode C. Mode C may be limited to a case where reroute takes place in mode A.

The behavior determination unit 172 determines a situation in which a lane change of the subject vehicle is required (hereafter, referred to as lane change required situation). An example of a lane change required situation is a situation in which a lane change from the subject vehicle's lane to a different lane is required because a number of lanes is reduced ahead of a course the subject vehicle takes. Another example of a lane change required situation is a situation in which a lane change from the subject vehicle's lane to a different lane is required for right or left turning along a planned route or going into a branch road. When a lane change required situation is determined, the behavior determination unit 172 determines whether a lane change is feasible. For example, whether a lane change is feasible can be determined according to whether a nearby vehicle exists within a target range in a lane as a destination of the lane change. A target range can be made arbitrarily settable. When a lane change required situation is determined and further a situation in which a lane change is feasible is determined, the behavior determination unit 172 determines execution of a lane change by automated driving (hereafter, referred to automatic lane change). When the behavior determination unit 172 determines execution of an automatic lane change, the LCA control unit 1731 of the control implementation unit 173 starts the automatic lane change.

The behavior determination unit 172 includes a setting state determination unit 1721, a searcher determination unit 1722, and an LC restriction unit 1723 as sub-functional blocks. The setting state determination unit 1721 determines a setting state, which is a state related to setting of a destination of the subject vehicle. The processing at the setting state determination unit 1721 is also equivalent to a setting state determination step. The setting state determination unit 1721 determines whether a destination has been set by an occupant of the subject vehicle as a setting state. When the behavior determination unit 172 has accepted input of a destination from an occupant and a long and mid-term traveling plan has been determined, the setting state determination unit 1721 can determine that a destination has been set by an occupant of the subject vehicle. When the behavior determination unit 172 has set a tentative destination as destination and a long and mid-term traveling plan has been determined, the setting state determination unit 1721 can determine that a destination has not been set by an occupant of the subject vehicle.

The setting state determination unit 1721 preferably determines whether reroute has taken place as a setting state. The setting state determination unit 1721 can determine whether reroute has taken place based on a result of determination at the behavior determination unit 172. When the behavior determination unit 172 has performed reroute, the setting state determination unit 1721 can determine whether reroute has taken place. When the behavior determination unit 172 has not performed reroute, the setting state determination unit 1721 can determine whether reroute has not taken place. The setting state determination unit 1721 preferably determines whether reroute has been completed as a setting state. The setting state determination unit 1721 can determines whether reroute has been completed based on a result of determination at the behavior determination unit 172. Completion of search for a new recommended route by reroute can be taken as completion of reroute.

The searcher determination unit 1722 determines that a destination has been searched for. The searcher determination unit 1722 can determine that a destination has been searched for from information of input for searching for a destination, accepted at the user input device 19. The searcher determination unit 1722 can acquire this information through the HCU communication unit 174. The searcher determination unit 1722 determines in accordance with whichever's instruction, a driver of the subject vehicle or any other occupant than the driver, a destination has been searched for. This processing can be performed when the searcher determination unit 1722 determines that a destination has been searched for. In a case where a destination is searched for by button operation with a touch panel or the like, the following procedure can be taken. The searcher determination unit 1722 can determine in accordance with whichever's instruction, a driver or an occupant, a destination has been searched for by performing image recognition with an image picked up with an interior camera of the subject vehicle. In a case where a destination is searched for by voice input, in accordance with whichever's instruction, a driver or an occupant, a destination has been searched for can be determined by voice spectrum authentication. The searcher determination unit 1722 may determine in accordance with whichever's instruction, a driver or an occupant, a destination has been searched for by any other method.

When a destination is being newly searched for in mode A or mode B based on a setting state determined at the setting state determination unit 1721 or when in mode C, the LC restriction unit 1723 restricts execution of an automatic lane change of the subject vehicle. The LC restriction unit 1723 is equivalent to a lane change restriction unit. The processing at the LC restriction unit 1723 is equivalent to a lane change restriction step. The LC restriction unit 1723 can discriminate a mode of the subject vehicle from an automation level determined at the level determination unit 102 and the above-mentioned setting state. The LC restriction unit 1723 can discriminates that a destination is being newly searched for from a result of determination at the searcher determination unit 1722. The LC restriction unit 1723 can restrict execution of an automatic lane change by issuing an instruction to the LCA control unit 1731. Mode A is a state of the subject vehicle during automated driving free from a monitoring obligation with a destination set by an occupant of the subject vehicle. Mode B is a state of the subject vehicle during automated driving free from a monitoring obligation without a destination set by an occupant of the subject vehicle. When an automatic lane change has not been started, the LC restriction unit 1723 can prohibit the automatic lane change. When the subject vehicle is making an automatic lane change, the LC restriction unit 1723 can cancel the automatic lane change. When the subject vehicle is making an automatic lane change, the LC restriction unit 1723 may cause the automatic lane change to stand by.

In a case where a destination is newly searched for when the subject vehicle is in mode A and in mode B, a traveling direction of the subject vehicle must be highly probably changed. Also, in mode C, a traveling direction of the subject vehicle must be highly probably changed. When a change of traveling direction of a vehicle to a direction different from that of a lane change become necessary at a lane change time during automated driving free from a monitoring obligation, a driver can be required to cope with sudden driving operation. According to the above-mentioned configuration, to cope with the foregoing, when a traveling direction of the subject vehicle must be highly probably changed, execution of a lane change can be limited. Therefore, during automated driving free from a monitoring obligation, the subject vehicle is less prone to be required to cope with sudden driving operation. As a result, degradation in convenience can be suppressed during automated driving free from a monitoring obligation. Further, according to the above-mentioned configuration, a problem that an occupant falsely recognizes the occupant's operation, such as setting of a destination, has an influence on such the subject vehicle's behavior as lane change can be prevented.

In a case where the searcher determination unit 1722 determines that a destination has been searched for in accordance with an instruction from a driver, when a destination is being newly searched for in mode A or in mode B, the LC restriction unit 1723 preferably restricts execution of lane change is limited. Meanwhile, in a case where the searcher determination unit 1722 determines that a destination has been searched for in accordance with an instruction from an occupant, even when a destination is being newly searched for in mode A or in mode B, the LC restriction unit 1723 preferably restricts execution of lane change. When a destination has been searched for in accordance with an occupant's instruction, a driver can easily cope with sudden driving operation as compared with when a destination has been searched for in accordance with the driver's instruction. Therefore, according to the above-mentioned configuration, execution of lane change can be restricted only when it is difficult for a driver to cope with sudden driving operation.

When the LC restriction unit 1723 restricts execution of lane change, the notification processing unit 1741 of the HCU communication unit 174 can cause the notification device 18 to notify that execution of lane change is restricted. For example, notification that execution of lane change is restricted can be made as described below. Notification that execution of lane change is restricted will be hereafter referred to as LC restriction notification.

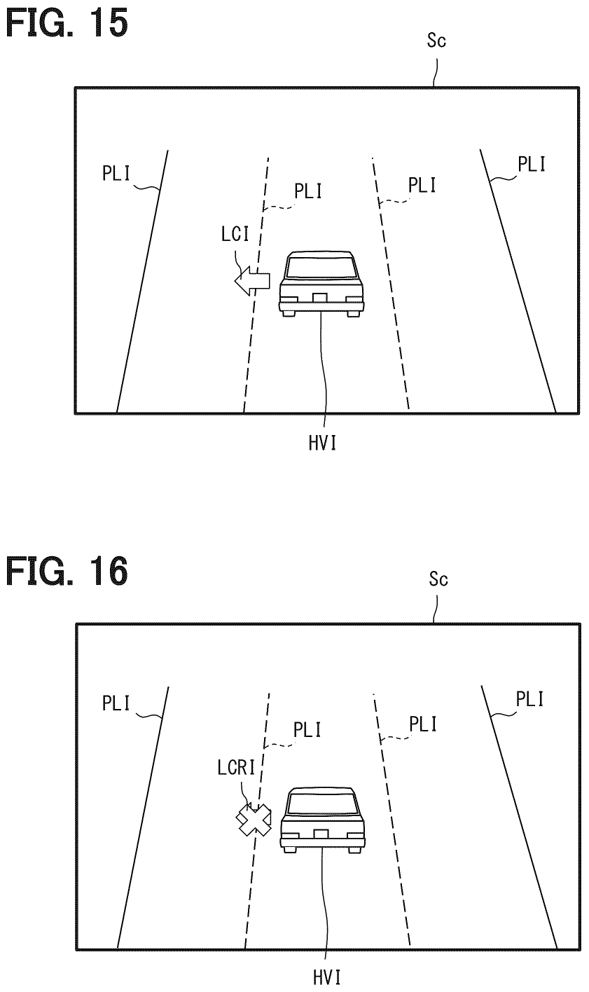

A description will be given to an example of LC restriction notification with reference to FIG. 15 to FIG. 16. FIG. 15 is an example of display of an image (hereafter, referred to as surrounding situation image) for showing a surrounding situation of the subject vehicle obtained when execution of lane change is not restricted. FIG. 16 is an example of display of a surrounding situation image obtained when execution of lane change is restricted. A surrounding situation image is displayed, for example, in a meter MID. An overhead image of the subject vehicle and the periphery thereof as viewed from a virtual viewpoint above the subject vehicle can be taken as a surrounding situation image. This virtual viewpoint may be located immediately above the subject vehicle or may be in a position shifted from immediately above the subject vehicle. For example, an overhead image may be an overhead view as viewed from a virtual viewpoint above and behind the subject vehicle. A surrounding situation image may be a virtual image for showing a surrounding situation of the subject vehicle or may be one obtained by processing an image picked up with the surround monitoring camera among the surround monitoring sensor 15.

Sc in FIG. 15 to FIG. 16 denotes a display screen of the meter MID. PLI in FIG. 15 to FIG. 6 denotes an image indicating a partition line between lanes (hereafter, referred to as partition line image). HVI in FIG. 15 to FIG. 16 denotes an image indicating the subject vehicle (hereafter, referred to as subject vehicle image). LCI in FIG. 15 to FIG. 16 denotes an image indicating an automatic lane change of the subject vehicle (hereafter, referred to as LC image). In FIG. 15 to FIG. 16, an icon of an arrow indicating a direction to which the subject vehicle makes an automatic lane change is shown as an example of an LC image. An image or the like indicating a vehicle speed of the subject vehicle may be displayed in a surrounding situation image.

As shown in FIG. 15, that execution of a lane change of the subject vehicle is not restricted can be expressed by displaying an LC image. As shown in FIG. 16, that execution of a lane change is restricted can be expressed by displaying an LC restriction image with a mark indicating interruption superimposed over an LC image. LCRI in FIG. 16 denotes an LC restriction image. That execution of lane change of the subject vehicle is restricted may be represented by any other expression, such as text display. In addition, that execution of lane change of the subject vehicle may also be notified by voice output from the voice output device 182.

<LC Standby Related Processing at Automated Driving ECU 17e>

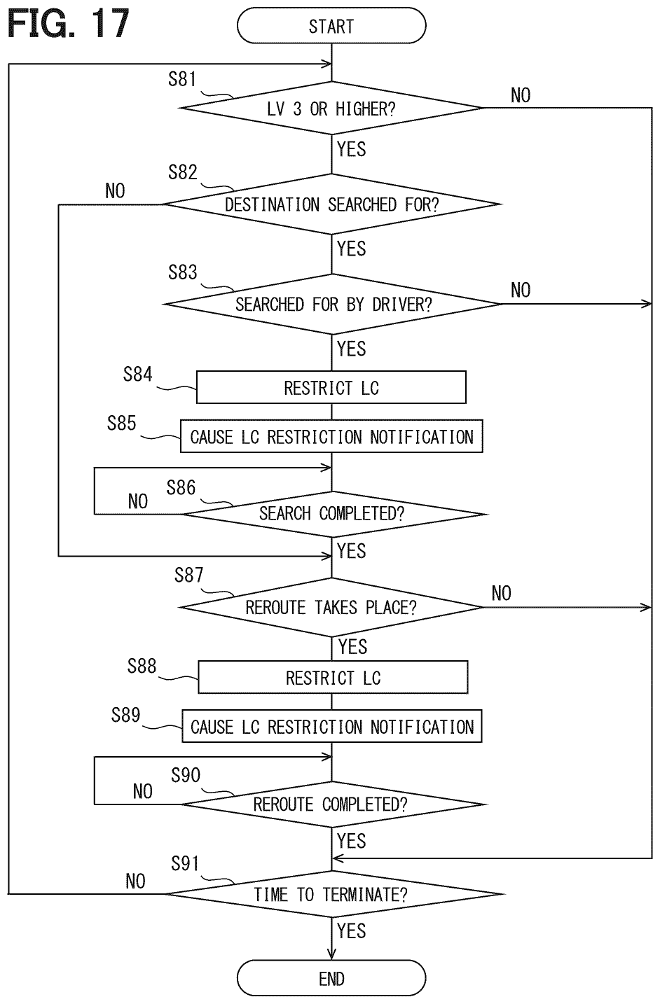

A description will be given to an example of a flow of processing (hereafter, referred to as LC restriction related processing) related to restriction of automatic lane change at the automated driving ECU 17e with reference to the flowchart in FIG. 17. The flowchart in FIG. 17 can be so configured as to be started, for example, when the power switch is turned on. Aside from the foregoing, when a configuration in which an automated driving function can be switched between on and off is adopted, the flowchart can be so configured that that the automated driving function is on is also added to a condition.

First, at Step S81, an automation level of the subject vehicle determined at the level determination unit 102 is LV 3 or higher levels (YES at S81), the processing proceeds to Step S82. Meanwhile, when an automation level of the subject vehicle is lower than LV 3 (NO at S81), the processing proceeds to Step S91.

At Step S82, the searcher determination unit 1722 determines that a destination has been searched for (YES at S82), the processing proceeds to Step S83. Meanwhile, when the searcher determination unit 1722 determines that a destination has not been searched for (NO at S82), the processing proceeds to Step S87.

At Step S83, the searcher determination unit 1722 determines that a destination has been searched for in accordance with a driver's instruction (YES at S83), the processing proceeds to Step S84. Meanwhile, when the searcher determination unit 1722 determines that a destination has been searched for in accordance with an occupant's instruction (NO at S83), the processing proceeds to Step S91. At Step S84, the LC restriction unit 1723 restricts execution of automatic lane change of the subject vehicle. At Step S85, the notification processing unit 1741 causes LC restriction notification.

At Step S86, the setting state determination unit 1721 determines that search for a destination has been completed (YES at S86), the processing proceeds to Step S87. Meanwhile, when the setting state determination unit 1721 determines that search for a destination has not been completed (NO at S86), the processing of Step S86 is repeated. For example, when a recommended route is searched for with respect to a newly set destination, the setting state determination unit 1721 can determines that the search for a destination has been completed.

At Step S87, the setting state determination unit 1721 determines that reroute has taken place (YES at S87), the processing proceeds to Step S88. Meanwhile, when the setting state determination unit 1721 determines that reroute has not taken place (NO at S87), the processing proceeds to Step S91. At Step S88, the LC restriction unit 1723 restricts execution of automatic lane change of the subject vehicle. At Step S89, the notification processing unit 1741 causes LC restriction notification.

At Step S90, the setting state determination unit 1721 determines that reroute has been completed (YES at S90), and proceeds to Step S91. Meanwhile, when the setting state determination unit 1721 determines that reroute has not been completed (NO at S90), the processing of S90 is repeated.

At Step S91, it is time to terminate the LC restriction related processing (YES at S91), the LC restriction related processing is terminated. Meanwhile, when it is not time to terminate the LC restriction related processing (NO at S91), the processing returns to S81 and is repeated. Examples of time to terminate LC restriction related processing is that the power switch is turned off, that the automated driving function is turned off, and the like.

### (Ninth Embodiment)

The present disclosure need not be configured as in the above-mentioned embodiments and may be configured as in the ninth embodiment described below.

Hereafter, a description will be given to an example of a configuration of the ninth embodiment with reference to the drawings.

<General Configuration of Vehicular System 1f>

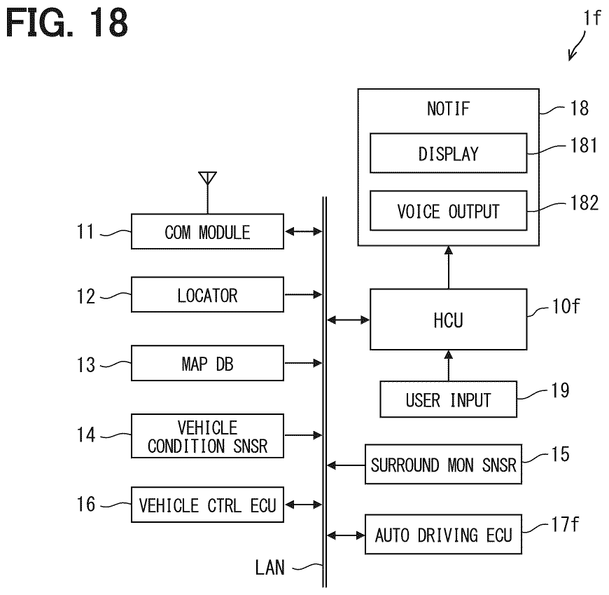

The vehicular system 1f shown in FIG. 18 can be used in an automated driving vehicle. As shown in FIG. 18, the vehicular system 1f includes: the HCU 10f, the communication module 11, the locator 12, the map DB 13, the vehicle condition sensor 14, the surround monitoring sensor 15, the vehicle control ECU 16, the automated driving ECU 17f, the notification device 18, and the user input device 19. The vehicular system 1f in the ninth embodiment includes the HCU 10f in place of the HCU 10. The vehicular system 1f includes the automated driving ECU 17f in place of the automated driving ECU 17. The vehicular system 1f is identical with the vehicular system 1 in the first embodiment except these respects.

The automated driving ECU 17f is identical with the automated driving ECU 17 in the first embodiment except that a speed of the subject vehicle is suppressed in accordance with information from the HCU 10f. The HCU 10f is identical with the HCU 10 in the first embodiment except that some processing is different.

<General Configuration of HCU 10f>

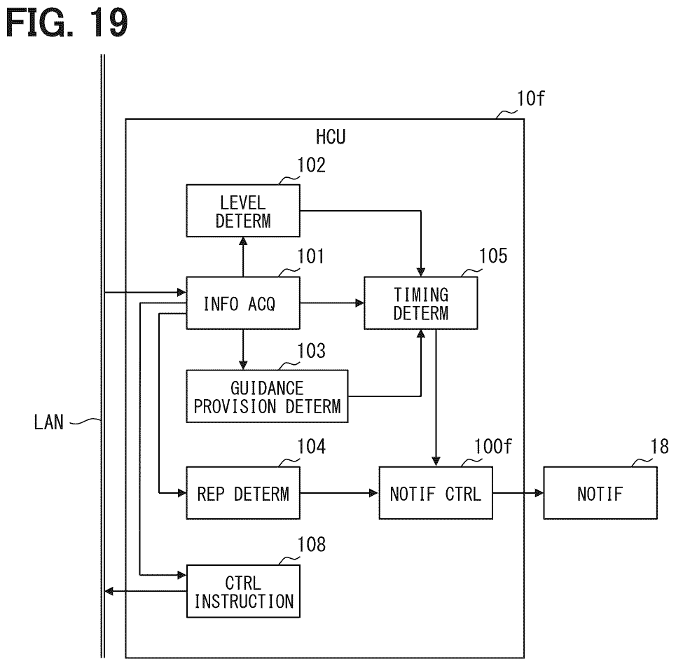

A description will be given to a general configuration of the HCU 10f with reference to FIG. 19. With respect to control and the like of notification at the notification device 18, as shown in FIG. 19, the HCU 10f includes, as functional blocks, a notification control unit 100f, the information acquisition unit 101, the level determination unit 102, the guidance provision determination unit 103, the repetition determination unit 104, the timing determination unit 105, and a control instruction unit 108. The HCU 10f includes the notification control unit 100f in place of the notification control unit 100. The HCU 10f includes the control instruction unit 108. The HCU 10f is identical with the HCU 10 in the first embodiment except these respects. The HCU 10f is also equivalent to the control device for a vehicle. Execution of the processing of each functional block of the HCU 10f by the computer is also equivalent to execution of the control method for a vehicle.

The control instruction unit 108 performs the processing of outputting a signal to the automated driving ECU 17f. When a distance between the subject vehicle and the above-mentioned predetermined place becomes equal to a threshold value or below, the control instruction unit 108 outputs information for suppressing a speed of the subject vehicle to a specified value or below to the automated driving ECU 17f. According to the foregoing, when a distance between the subject vehicle and the predetermined place becomes equal to the threshold value or below, a speed of the subject vehicle is suppressed to a specified value or below. The threshold value cited here may be 0 or may be a value larger than 0. A specified value can be made arbitrarily settable. A speed at such a level as to be considerable as low speed can be taken as the specified value. According to the foregoing, when the subject vehicle approaches or arrives at a predetermined place, a speed of the subject vehicle can be suppressed to low speed. The control instruction unit 108 is equivalent to a speed control instruction unit. The control instruction unit 108 can acquire information of a distance between the subject vehicle and a predetermined place from the travel environment recognition unit of the automated driving ECU 17 through the information acquisition unit 101.

The notification control unit 100f is identical with the notification control unit 100 in the first embodiment except that some processing is different. Hereafter, a description will be given to this difference. The notification control unit 100f causes at least the above-mentioned traveling situation notification as prompting notification. When the guidance provision determination unit 103 determines that occupant set route guidance is not under way during automated driving free from a monitoring obligation of the subject vehicle, the notification control unit 100f causes situation notification notifying of a traveling situation on place timing, which corresponds to time when the subject vehicle arrives at the above-mentioned predetermined place. This processing at the notification control unit 100f is also equivalent to a notification control step.

According to the configuration of the ninth embodiment, since the subject vehicle can be suppressed to low speed at or in front of a predetermined place where situation notification should be caused, a driver can be made to more easily grasp a traveling situation of the subject vehicle. The configuration of the ninth embodiment may be combined with the configurations of the second to fifth embodiments. In relation to the ninth embodiment, a configuration in which the HCU 10f bears the functions of the speed control instruction unit has been described but the present disclosure need not be configured as mentioned above. For example, the present disclosure may be so configured that the automated driving ECU 17f bears the functions of the speed control instruction unit. In this case, a configuration embracing the HCU 10f and the automated driving ECU 17f is equivalent to the control device for a vehicle.

### (Tenth Embodiment)

The present disclosure need not be configured as in the above-mentioned embodiments and may be configured as in the tenth embodiment described below.

Hereafter, a description will be given to an example of a configuration of the tenth embodiment with reference to the drawings.

<General Configuration of Vehicular System 1g>

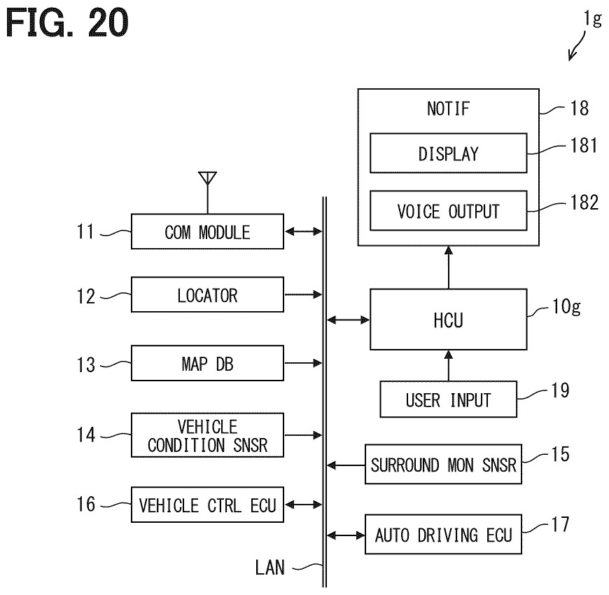

The vehicular system 1g shown in FIG. 20 can be used in an automated driving vehicle. An automated driving vehicle using the vehicular system 1g can switch between sleep-permitted automated driving and sleep-prohibited automated driving and perform these types of automated driving. The sleep-permitted automated driving is the automated driving of LV 4 or higher level. In the present embodiment, as an example, the sleep-permitted automated driving is defined as the automated driving of LV 4. The sleep-prohibited automated driving is defined as the automated driving of LV 3.

As shown in FIG. 20, the vehicular system 1g includes: the HCU 10g, the communication module 11, the locator 12, the map DB 13, the vehicle condition sensor 14, the surround monitoring sensor 15, the vehicle control ECU 16, the automated driving ECU 17, the notification device 18, and the user input device 19.

The vehicular system 1g is identical with the vehicular system 1 in the first embodiment except that HCU 10g is included in place of the HCU 10.

<General Configuration of HCU 10g>

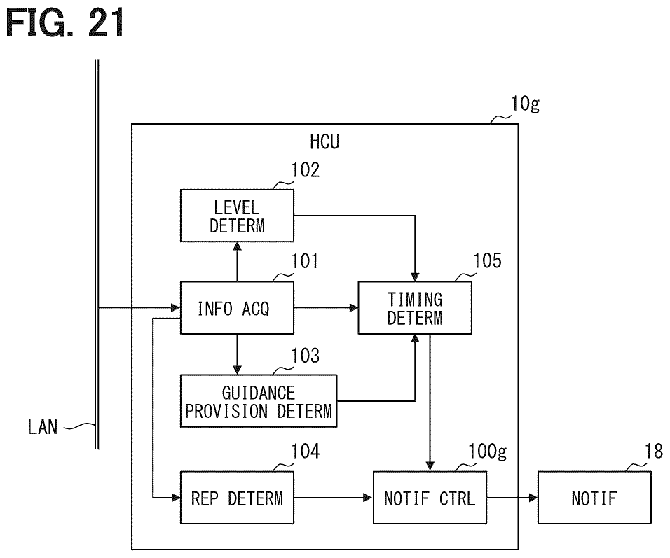

A description will be given to a general configuration of the HCU 10g with reference to FIG. 21. With respect to control of notification at the notification device 18, as shown in FIG. 21, the HCU 10g includes, as functional blocks, a notification control unit 100g, the information acquisition unit 101, the level determination unit 102, the guidance provision determination unit 103, the repetition determination unit 104, and the timing determination unit 105. The HCU 10g is identical with the HCU 10 in the first embodiment except that the notification control unit 100g is provided in place of the notification control unit 100. The HCU 10g is also equivalent to the control device for a vehicle. Execution of the processing of each functional block of the HCU 10g by the computer is also equivalent to execution of the control method for a vehicle.

The notification control unit 100g is identical with the notification control unit 100 in the first embodiment except that some processing is different. Hereafter, a description will be given to this difference. When the guidance provision determination unit 103 determines that occupant set route guidance is not under way during automated driving free from a monitoring obligation of the subject vehicle, the notification control unit 100g varies a frequency of notification as situation notification notifying that occupant set route guidance is not under way in the subject vehicle according to whether the subject vehicle is during sleep-permitted automating driving or sleep-prohibited automated driving. This notification will be hereafter referred to as non-route guidance notification. Whether the subject vehicle is during sleep-permitted automated driving or sleep-prohibited automated driving can be discriminated from an automation level determined at the level determination unit 102. According to the above-mentioned configuration, when that a frequency of non-route guidance notification differs depending on whether the subject vehicle is during sleep-permitted automated driving or during sleep-prohibited automated driving is favorable for an occupant of the subject vehicle, non-route guidance notification can be made at a frequency favorable for the occupant of the subject vehicle. This processing at the notification control unit 100g is also equivalent to a notification control step.

When the subject vehicle is during sleep-permitted automated driving, the notification control unit 100g preferably increases a frequency of non-route guidance notification as compared with a case where the subject vehicle is during sleep- prohibited automated driving. During sleep-permitted automated driving, a driver can sleep. Therefore, there is a danger that driving is continued without a destination set as compared with a case where the subject vehicle is during sleep-prohibited automated driving. According to the above-mentioned configuration, a frequency of non-route guidance notification can be increased with increase in possibility that driving is continued without a destination set. Therefore, driving is easily suppressed from being continued without a destination set.

When the subject vehicle is during sleep-permitted automated driving, the notification control unit 100g may be so configured that a frequency of non-route guidance notification is reduced as compared with a case where the subject vehicle is during sleep-prohibited automated driving. During sleep-permitted automated driving, a driver can sleep. Therefore, it is guessed that an occupant may desire to reduce a frequency of notification as compared with a case where the subject vehicle is during sleep-prohibited automated driving. According to the above-mentioned configuration, a frequency of non-route guidance notification can be reduced according to a request from an occupant who desires to reduce a frequency of notification.

### (Eleventh Embodiment)

The present disclosure need not be configured as in the above-mentioned embodiments and may be configured as in the eleventh embodiment described below. Hereafter, a description will be given to an example of a configuration of the eleventh embodiment with reference to the drawings.

<General Configuration of Vehicular System 1h>

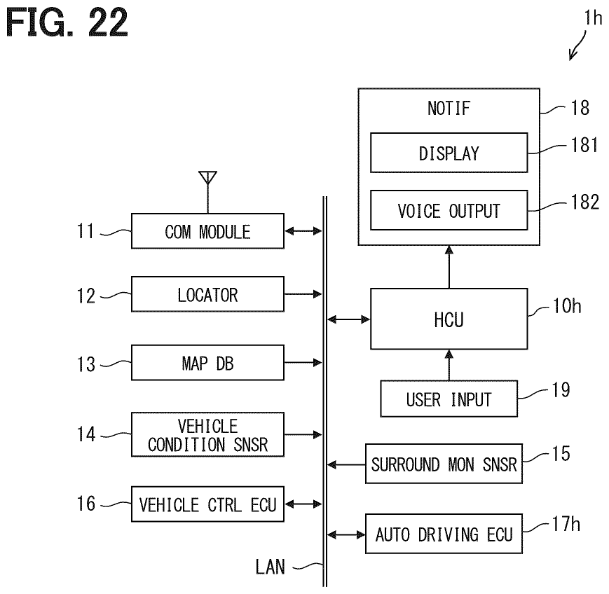

The vehicular system 1h shown in FIG. 22 can be used in an automated driving vehicle. As shown in FIG. 22, the vehicular system 1h includes: the HCU 10h, the communication module 11, the locator 12, the map DB 13, the vehicle condition sensor 14, the surround monitoring sensor 15, the vehicle control ECU 16, the automated driving ECU 17h, the notification device 18, and the user input device 19. The vehicular system 1h includes the HCU 10h in place of the HCU 10. The vehicular system 1h includes the automated driving ECU 17h in place of the automated driving ECU 17. The vehicular system 1h is identical with the vehicular system 1 in the first embodiment except these respects.

The automated driving ECU 17h is identical with the automated driving ECU 17 in the first embodiment except that whether to continue automated driving free from a monitoring obligation of the subject vehicle is switched according to information from the HCU 10h. When automated driving free from a monitoring obligation is discontinued, the automated driving ECU 17h causes a driving change from automated driving free from a monitoring obligation. The driving change cited here is a driving change to monitoring obligated automated driving, which is automated driving free from a surround monitoring obligation, or manual driving. To cause a driving change, the automated driving ECU 17h can instruct the HCU 10h to make notification prompting a driving change. Then, for example, when a grasp on the steering of the subject vehicle is detected, a driving change can be effected. A grasp on the steering can be detected based on, for example, a signal from such a sensor as a pressure-sensitive sensor provided on the steering.

<General Configuration of HCU 10h>

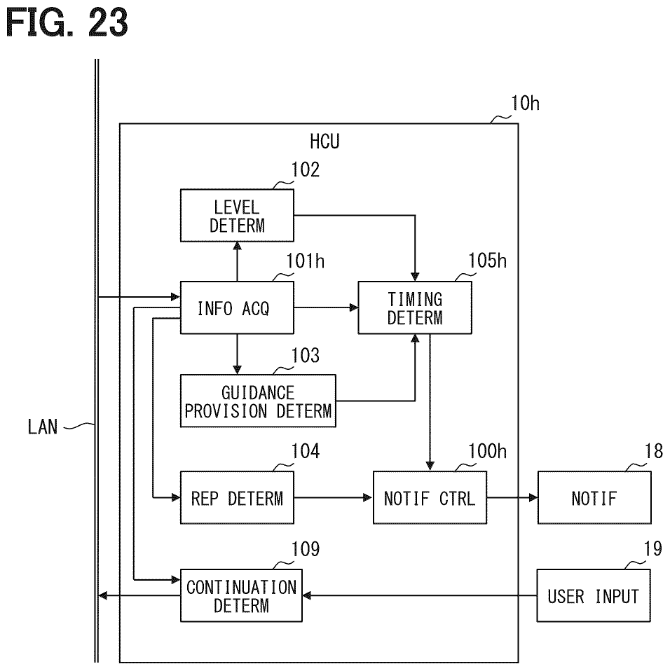

A description will be given to a general configuration of the HCU 10h with reference to FIG. 23. With respect to control and the like of notification at the notification device 18, as shown in FIG. 23, the HCU 10h includes, as functional blocks, a notification control unit 100h, an information acquisition unit 101h, the level determination unit 102, the guidance provision determination unit 103, the repetition determination unit 104, a timing determination unit 105h, and a continuation determination unit 109. The HCU 10h includes the notification control unit 100h in place of the notification control unit 100. The HCU 10h includes the information acquisition unit 101h in place of the information acquisition unit 101. The HCU 10h includes the timing determination unit 105h in place of the timing determination unit 105. The HCU 10h includes the continuation determination unit 109. The HCU 10h is identical with the HCU 10 in the first embodiment except these respects. The HCU 10h is also equivalent to the control device for a vehicle. Execution of the processing of each functional block of the HCU 10h by the computer is also equivalent to execution of the control method for a vehicle.

The information acquisition unit 101h is identical with the HCU 10 in the first embodiment except that some processing is different. Hereafter, a description will be given to this difference. The information acquisition unit 101h acquires information that enables whether the steering is operated by a driver to be determined. For example, a signal from a steering torque sensor can be acquired. The steering torque sensor is a sensor that detects a steering wheel torque applied to a steering wheel. In the following description, a case where this steering wheel torque is used as information that enables whether the steering is operated by a driver to be determined will be taken as an example.

The timing determination unit 105h is identical with the timing determination unit 105 in the first embodiment except that some processing is different. Hereafter, a description will be given to this difference. The timing determination unit 105h determines, as a predetermined timing, (hereafter, referred to as transition timing) when a transition is made from a state in which the guidance provision determination unit 103 determines that occupant set route guidance is under way to a state in which the guidance provision determination unit determines that occupant set route guidance is not under way. A transition from a state in which the guidance provision determination unit 103 determines that occupant set route guidance is under way to a state in which the guidance provision determination unit determines that occupant set route guidance is not under way will be hereafter referred to as non-route guidance transition. A non-route guidance transition occurs when an occupant of the subject vehicle cancels route guidance during driving of the subject vehicle. Cancel of route guidance can be accepted at the user input device 19. Cancel of route guidance may be reworded as canceling of setting of a destination.

The notification control unit 100h is identical with the notification control unit 100 in the first embodiment except that some processing is different. Hereafter, a description will be given to this difference. When a non-route guidance transition is made during automated driving free from a monitoring obligation of the subject vehicle, the notification control unit 100h can cause setting prompting notification prompting setting of a destination as confirmation notification. That is, the notification control unit 100h causes setting prompting notification on transition timing determined at the timing determination unit 105h during automated driving free from a monitoring obligation of the subject vehicle. The notification control unit 100h can determine that a non-route guidance transition has been made from a result of determination at the guidance provision determination unit 103. When a non-route guidance transition is made during automated driving free from a monitoring obligation of the subject vehicle, the notification control unit 100h may cause notification confirming whether to continue automated driving free from a monitoring obligation (hereafter, referred to as continuation confirming notification). Examples of continuation confirming notification include text display, voice output, and the like announcing “Continue LV 3 automated driving?” When a non-route guidance transition is made during automated driving free from a monitoring obligation of the subject vehicle, the notification control unit 100h causes at least either setting prompting notification or continuation confirming notification. This processing at the notification control unit 100h is also equivalent to a notification control step.

According to the above-mentioned configuration, an occupant of the subject vehicle can confirm that a non-route guidance transition has been made by at least either setting prompting notification or continuation confirming notification. Therefore, an occupant of the subject vehicle can easily confirm that cancel of route guidance during driving of the subject vehicle is reflected in a system of the vehicle.

When a non-route guidance transition is made during automated driving free from a monitoring obligation of the subject vehicle, the continuation determination unit 109 preferably determines whether to continue automated driving free from a monitoring obligation in accordance with at least either a driver's operation related to a second task or the driver's steering operation. The continuation determination unit 109 can determine a driver's operation related to a second task, for example, from a signal from an operating device used for second tasks of the user input device 19. Operating devices used for second tasks include a touch switch of CID used for viewing a video and the like. The continuation determination unit 109 can determine a driver's steering operation, for example, from a steering wheel torque acquired at the information acquisition unit 101h.

It is guessed that a driver's operation related to a second task and a driver's steering operation differ depending on whether to continue automated driving free from a monitoring obligation. Therefore, according to the above-mentioned configuration, whether to continue automated driving free from a monitoring obligation can be more accurately determined based on at least either a driver's operation related to a second task or a driver's steering operation.

When a non-route guidance transition is made during automated driving free from a monitoring obligation of the subject vehicle, the continuation determination unit 109 is preferably capable of determining whether to continue the automated driving free from a monitoring obligation according to both a driver's operation related to a second task and a driver's steering operation. When a driver's operation related to a second task takes place, the continuation determination unit 109 can determine that automated driving free from a monitoring obligation is continued and cause the automated driving free from a monitoring obligation to be continued. To cause automated driving free from a monitoring obligation to be continued, the continuation determination unit 109 can output information for continuing the automated driving free from a monitoring obligation to the automated driving ECU 17h. As a result, the automated driving ECU 17h continues the automated driving free from a monitoring obligation. Meanwhile, when a driver's steering operation takes place, the continuation determination unit 109 determines that the automated driving free from a monitoring obligation is not continued and causes a transition to driving change. When causing a transition to driving change, the continuation determination unit 109 can output information for making a transition to driving change to the automated driving ECU 17h. As a result, the automated driving ECU 17h performs processing for making a transition to driving change. Processing for making a transition to driving change is processing prompting a driver to make a driving change, processing for making a transition from automated driving free from a monitoring obligation to monitoring obligated automated driving or manual driving, and the like.

In a case where a non-route guidance transition is made during automated driving free from a monitoring obligation of the subject vehicle, when a driver's operation related to a second task takes place, the driver highly probably desires to continue the automated driving free from a monitoring obligation. Meanwhile, in a case where a non-route guidance transition is made during automated driving free from a monitoring obligation of the subject vehicle, when a driver's steering operation takes place, the driver does not highly probably desire to continue the automated driving free from a monitoring obligation. Therefore, when a non-route guidance transition is made during automated driving free from a monitoring obligation of the subject vehicle, whether to continue the automated driving free from a monitoring obligation can be switched according to the driver's request.

When a driver's operation related to a second task takes place, the continuation determination unit 109 may be so configured as to determine that automated driving free from a monitoring obligation is not continued and cause a transition to driver change. When a driver's steering operation takes place, the continuation determination unit 109 may be so configured as to determine that automated driving free from a monitoring obligation is continued and cause the automated driving free from a monitoring obligation to be continued.

The configuration of the eleventh embodiment may be combined with the configurations of the second to fifth embodiments. The configuration of the eleventh embodiment may be combined with the configurations of the sixth to seventh embodiments. To combine the configuration of the eleventh embodiment with the configuration of the sixth embodiment, the HCU 10c, 10d only has to include the continuation determination unit 109 as a functional block. To combine the configuration of the eleventh embodiment with the configuration of the sixth embodiment, the notification control unit 100c can be made to bear the functions of the notification control unit 100h. In this case, the notification control unit 100c is equivalent to a notification instruction unit. To combine the configuration of the eleventh embodiment with the configuration of the seventh embodiment, the notification control unit 100d can be made to bear the functions of the notification control unit 100h. In this case, the notification control unit 100d is equivalent to a notification instruction unit.

### (Twelfth Embodiment)

The present disclosure need not be configured as in the above-mentioned embodiments and may be configured as in the twelfth embodiment described below.

Hereafter, a description will be given to an example of a configuration of the twelfth embodiment with reference to the drawings.

<General Configuration of Vehicular System 1i>

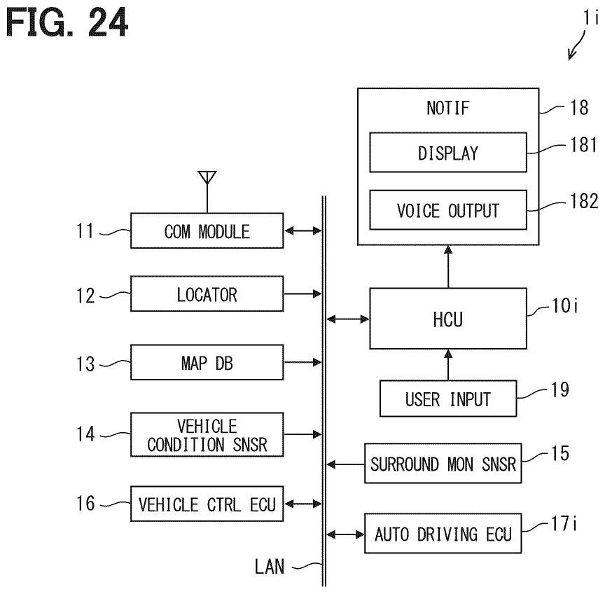

The vehicular system 1i shown in FIG. 24 can be used in an automated driving vehicle. As shown in FIG. 24, the vehicular system 1i includes: the HCU 10i, the communication module 11, the locator 12, the map DB 13, the vehicle condition sensor 14, the surround monitoring sensor 15, the vehicle control ECU 16, the automated driving ECU 17i, the notification device 18, and the user input device 19. The vehicular system 1i includes the HCU 10i in place of the HCU 10e. The vehicular system 1i includes the automated driving ECU 17i in place of the automated driving ECU 17e. The vehicular system 1i is identical with the vehicular system 1e in the eighth embodiment except these respects.

The HCU 10i is identical with the HCU 10e in the eighth embodiment except that notification is made in accordance with an instruction from the automated driving ECU 17i. The HCU 10i may be so configured as not to perform the notification control related processing described in relation to the first embodiment.

<General Configuration of Automated Driving ECU 17i>

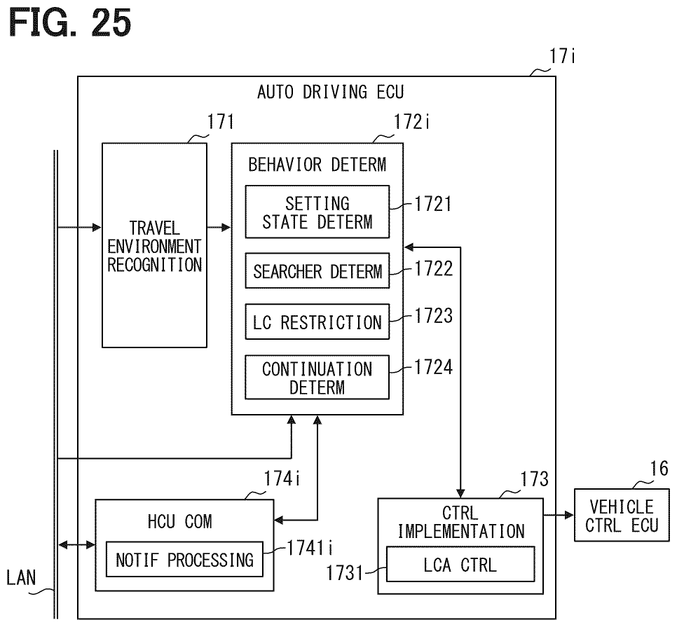

A description will be given to a general configuration of the automated driving ECU 17i with reference to FIG. 25. As shown in FIG. 25, the automated driving ECU 17i includes the travel environment recognition unit 171, a behavior determination unit 172i, the control implementation unit 173, and an HCU communication unit 174i as functional blocks. The automated driving ECU 17i includes the behavior determination unit 172i in place of the behavior determination unit 172. The automated driving ECU 17i includes the HCU communication unit 174i in place of the HCU communication unit 174. The automated driving ECU 17i is identical with the automated driving ECU 17e in the eighth embodiment except these respects. The automated driving ECU 17i is also equivalent to the control device for a vehicle. Execution of the processing of each functional block of the automated driving ECU 17i by the computer is also equivalent to execution of the control method for a vehicle.

The HCU communication unit 174i includes a notification processing unit 1741i as a sub-functional block. The HCU communication unit 174i is identical with the HCU communication unit 174 in the eighth embodiment except that the notification processing unit 1741i is provided in place of the notification processing unit 1741.

When a non-route guidance transition is made during automated driving free from a monitoring obligation of the subject vehicle, the notification processing unit 1741i can cause setting prompting notification to prompt setting of a destination.

The notification processing unit 1741i can determine whether the subject vehicle is during automated driving free from a monitoring obligation from a result of determination at the behavior determination unit 172i. The notification processing unit 1741i can send an instruction to the HCU 10i to cause the notification device 18 to make setting prompting notification. The setting prompting notification is identical with the setting prompting notification described in relation to the first embodiment.

Though described also in relation to the eleventh embodiment, the non-route guidance transition refers to a transition from a state in which it is determined that occupant set route guidance is under way to a state in which it is determined that occupant set route guidance is not under way. The notification processing unit 174i can determine that a non-route guidance transition has been made from a result of determination at the guidance provision determination unit 103 of the HCU 10i. When a non-route guidance transition is made during automated driving free from a monitoring obligation of the subject vehicle, the notification processing unit 174i can cause the above-mentioned continuation confirming notification. When a non-route guidance transition is made during automated driving free from a monitoring obligation of the subject vehicle, the notification processing unit 174i causes at least either setting prompting notification or continuation confirming notification. This processing at the notification processing unit 1741i is also equivalent to a notification control step.

According to the above-mentioned configuration, an occupant of the subject vehicle can confirm that a non-route guidance transition has been made by at least either setting prompting notification or continuation confirming notification. Therefore, an occupant of the subject vehicle can easily confirm that cancel of route guidance during driving of the subject vehicle is reflected in a system of the vehicle.

The behavior determination unit 172i includes a setting state determination unit 1721, the searcher determination unit 1722, the LC restriction unit 1723, and a continuation determination unit 1724 as sub-functional blocks. The behavior determination unit 172i is identical with the behavior determination unit 172 in the eighth embodiment except that the continuation determination unit 1724 is provided.

When a non-route guidance transition is made during automated driving free from a monitoring obligation of the subject vehicle, the continuation determination unit 1724 preferably determines whether to continue the automated driving free from a monitoring obligation in accordance with at least either a driver's operation related to a second task or the driver's steering operation. The continuation determination unit 1724 can determine a driver's operation related to a second task, for example, from a signal from an operating device used for second tasks of the user input device 19. A signal from the operating device can be acquired through the HCU communication unit 174i. Operating devices used for second tasks include a touch switch of CID used for viewing a video and the like. The continuation determination unit 1724 can determine a driver's steering operation from a steering wheel torque acquired through the LAN.

It is guessed that a driver's operation related to a second task and a driver's steering operation differ depending on whether to continue automated driving free from a monitoring obligation. Therefore, according to the above-mentioned configuration, whether to continue automated driving free from a monitoring obligation can be more accurately determined based on at least either a driver's operation related to a second task or a driver's steering operation.

When a non-route guidance transition is made during automated driving free from a monitoring obligation of the subject vehicle, the continuation determination unit 1724 is preferably capable of determining whether to continue the automated driving free from a monitoring obligation according to both a driver's operation related to a second task and the driver's steering operation. When a driver's operation related to a second task takes place, the continuation determination unit 1724 can determine that automated driving free from a monitoring obligation is continued and cause the automated driving free from a monitoring obligation to be continued. As a result, the control implementation unit 173 continues the automated driving free from a monitoring obligation. Meanwhile, when a driver's steering operation takes place, the continuation determination unit 1724 determines that automated driving free from a monitoring obligation is not continued and causes a transition to driving change. To cause a transition to driving change, the continuation determination unit 1724 can cause the HCU 10i to make notification prompting a driver to make a driving change through the HCU communication unit 174i. Then, for example, when a grasp on the steering of the subject vehicle is detected, the continuation determination unit 1724 can cause a driving change. A grasp on the steering can be detected based on, for example, a signal from such a sensor as a pressure-sensitive sensor provided on the steering.

In a case where a non-route guidance transition is made during automated driving free from a monitoring obligation of the subject vehicle, when a driver's operation related to a second task takes place, the driver highly probably desires to continue the automated driving free from a monitoring obligation. Meanwhile, in a case where a non-route guidance transition is made during automated driving free from a monitoring obligation of the subject vehicle, when a driver's steering operation takes place, the driver does not highly probably desire to continue the automated driving free from a monitoring obligation. Therefore, when a non-route guidance transition is made during automated driving free from a monitoring obligation of the subject vehicle, whether to continue the automated driving free from a monitoring obligation can be switched according to the driver's request.

When a driver's operation related to a second task takes place, the continuation determination unit 1724 may be so configured as to determine that automated driving free from a monitoring obligation is not continued and cause a transition to driving change. Further, when a driver's steering operation takes place, the continuation determination unit 1724 may be so configured as to determine that automated driving free from a monitoring obligation is continued and cause the automated driving free from a monitoring obligation to be continued.

### (Thirteenth Embodiment)

The present disclosure need not be configured as in the above-mentioned embodiments and may be configured as in the thirteenth embodiment described below. Hereafter, a description will be given to an example of a configuration of the thirteenth embodiment with reference to the drawings.

<General Configuration of Vehicular System 1j>

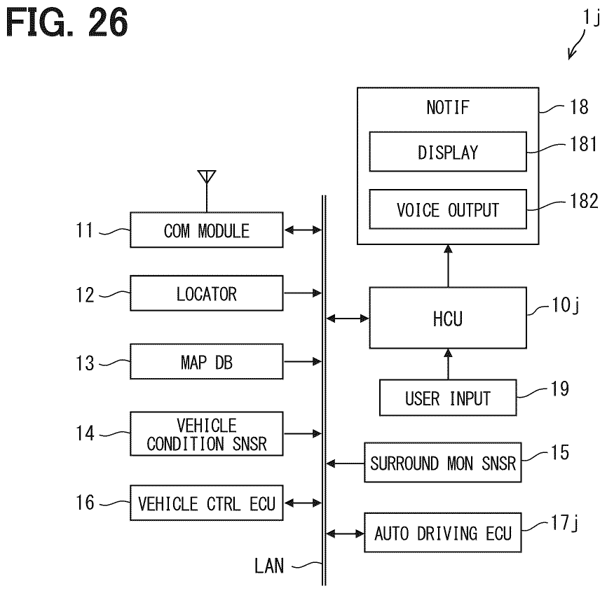

The vehicular system 1j shown in FIG. 26 can be used in an automated driving vehicle. As shown in FIG. 26, the vehicular system 1j includes: the HCU 10j, the communication module 11, the locator 12, the map DB 13, the vehicle condition sensor 14, the surround monitoring sensor 15, the vehicle control ECU 16, the automated driving ECU 17j, the notification device 18, and the user input device 19. The vehicular system 1j includes the HCU 10j in place of the HCU 10e. The vehicular system 1j includes the automated driving ECU 17j in place of the automated driving ECU 17e. The vehicular system 1j is identical with the vehicular system 1e in the eighth embodiment except these respects.

The HCU 10j is identical with the HCU 10e in the eighth embodiment except that notification is made in accordance with an instruction from the automated driving ECU 17j. The HCU 10j may be so configured as not to perform the notification control related processing described in relation to the first embodiment.

<General Configuration of Automated Driving ECU 17j>

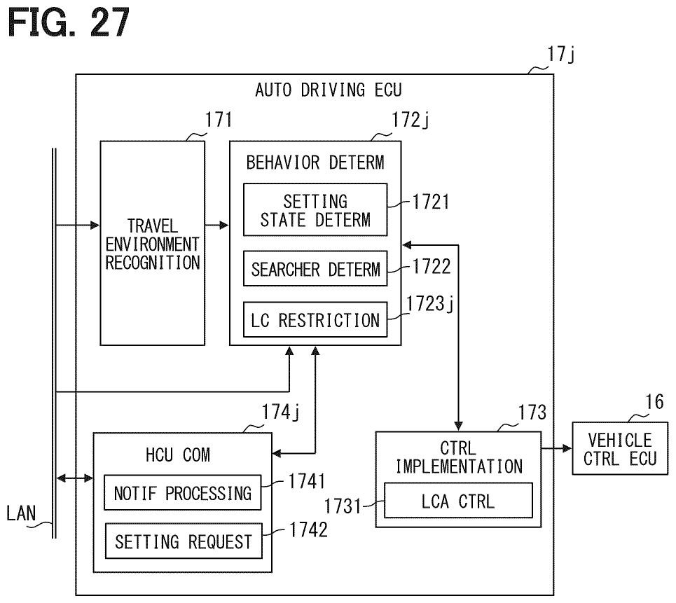

A description will be given to a general configuration of the automated driving ECU 17j with reference to FIG. 27. As shown in FIG. 27, the automated driving ECU 17j includes the travel environment recognition unit 171, the behavior determination unit 172, the control implementation unit 173, and an HCU communication unit 174j as functional blocks. The automated driving ECU 17j includes a behavior determination unit 172j in place of the behavior determination unit 172. The automated driving ECU 17j includes the HCU communication unit 174j in place of the HCU communication unit 174. The automated driving ECU 17j is identical with the automated driving ECU 17e in the eighth embodiment except these respects. The automated driving ECU 17j is also equivalent to the control device for a vehicle. Execution of the processing of each functional block of the automated driving ECU 17j by the computer is also equivalent to execution of the control method for a vehicle.

The HCU communication unit 174j includes a notification processing unit 1741 and a setting request unit 1742 as sub-functional blocks. The HCU communication unit 174j is identical with the HCU communication unit 174 in the eighth embodiment except that the setting request unit 1742 is provided.

The setting request unit 1742 causes a setting request requesting setting of a destination, higher in urgency than setting prompting notification prompting setting of a destination, toward an occupant of the subject vehicle. The setting prompting notification is identical with the setting prompting notification described in relation to the first embodiment. The setting request unit 1742 can send an instruction to the HCU 10j to cause the notification device 18 to make a setting request. The setting request is notification higher in urgency than setting prompting notification. For example, notification instructing setting of a destination, rather than prompting setting of a destination, can be adopted. Examples of setting requests include text display, voice output, and the like announcing “Set a destination.” A setting request may be made by display of a setting requesting icon. A setting request may be displayed in a meter MID, CID, or a display for rear seat.

When a situation in which setting of a destination is estimated to be highly urgent is detected, the setting request unit 1742 can cause a setting request. An example of a situation in which setting of a destination is estimated to be highly urgent is a case where automated driving free from a monitoring obligation has lasted for a specified time or longer without a destination set. The specified time can be made arbitrarily settable. Other examples include a situation in which the subject vehicle approaches a junction whose distance to the next junction is a specified value or larger, and the like. This is because when the subject vehicle goes into a section where driving along the road continues for a long time, an appropriate route through which the subject vehicle can swiftly go to a set destination, if any, is difficult to search for. A specified value can be made arbitrarily settable. That a distance to a target junction becomes smaller than an arbitrarily settable threshold value can be taken as approach.

The behavior determination unit 172j includes the setting state determination unit 1721, the searcher determination unit 1722, and an LC restriction unit 1723j as sub-functional blocks. The behavior determination unit 172j is identical with the behavior determination unit 172 in the eighth embodiment except that the LC restriction unit 1723j is provided in place of the LC restriction unit 1723.

When a destination is newly searched for in mode A or mode B based on a setting state determined at the setting state determination unit 1721 or when in mode C, like the LC restriction unit 1723, the LC restriction unit 1723j causes execution of an automatic lane change of the subject vehicle to be restricted. Mode A is a state of the subject vehicle during automated driving free from a monitoring obligation with a destination set by an occupant of the subject vehicle. Mode B is a state of the subject vehicle during automated driving free from a monitoring obligation without a destination set by an occupant of the subject vehicle. Mode C is a state of the subject vehicle during automated driving free from a monitoring obligation in which reroute takes place. The LC restriction unit 1723j is identical with the LC restriction unit 1723 in the eighth embodiment except that some processing is different. Hereafter, a description will be given to this difference. When a setting request is not made at the setting request unit 1742, the LC restriction unit 1723j prevents execution of an automatic lane change of the subject vehicle from being restricted. That is, when a new destination is searched for, that is, reroute is performed by setting of a destination by an occupant without a setting request, execution of an automatic lane change of the subject vehicle is prevented from being restricted. In other words, when a new destination is searched for, that is, reroute is performed by setting of a destination by an occupant after a setting request, execution of an automatic lane change of the subject vehicle is restricted. This LC restriction unit 1723j is also equivalent to a lane change restriction unit. Further, the processing at the LC restriction unit 1723j is also equivalent to a lane change restriction step.

When a setting request is made from the system side of a vehicle, it is guessed that the setting request is highly urgent. According to the above-mentioned configuration, execution of lane change can be restricted only when a destination is searched for, that is, reroute is performed in such a situation that an occupant is prone to panic. Therefore, a situation in which the subject vehicle is requested to cope with sudden driving operation when an occupant is prone to panic can be made less prone to occur. Meanwhile, when a situation in which an occupant is prone to panic does not occur, execution of lane change is not restricted; and thus, irritation to an occupant caused by imposing restriction can be suppressed.

### (Fourteenth Embodiment)

The present disclosure need not be configured as in the above-mentioned embodiments and may be configured as in the fourteenth embodiment described below. Hereafter, a description will be given to an example of a configuration of the fourteenth embodiment with reference to the drawings.

<General Configuration of Vehicular System 1k>

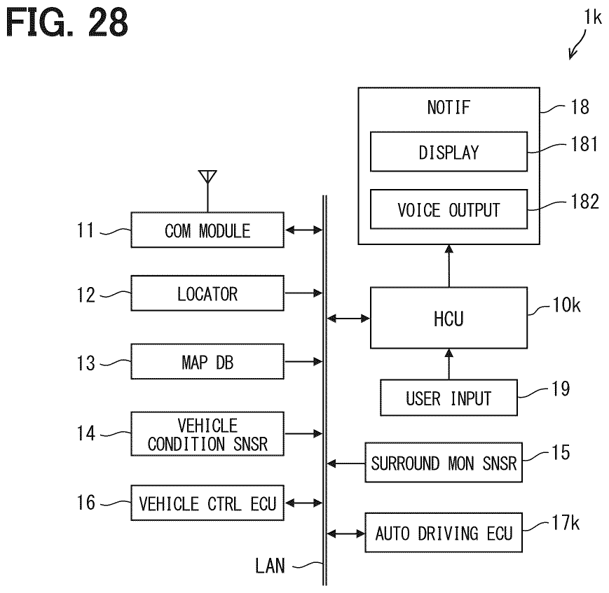

The vehicular system 1k shown in FIG. 28 can be used in an automated driving vehicle. As shown in FIG. 28, the vehicular system 1k includes: the HCU 10k, the communication module 11, the locator 12, the map DB 13, the vehicle condition sensor 14, the surround monitoring sensor 15, the vehicle control ECU 16, the automated driving ECU 17k, the notification device 18, and the user input device 19. The vehicular system 1k includes the HCU 10k in place of the HCU 10e. The vehicular system 1k includes the automated driving ECU 17k in place of the automated driving ECU 17e. The vehicular system 1k is identical with the vehicular system 1e in the eighth embodiment except these respects.

The HCU 10k is identical with the HCU 10e in the eighth embodiment except that notification is made in accordance with an instruction from the automated driving ECU 17k. The HCU 10k may be so configured as not to perform the notification control related processing described in relation to the first embodiment.

<General Configuration of Automated Driving ECU 17k>

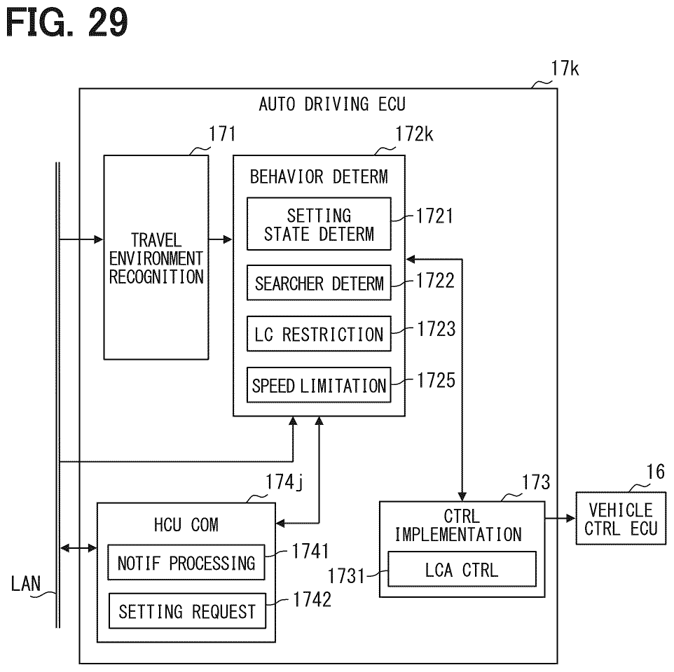

A description will be given to a general configuration of the automated driving ECU 17k with reference to FIG. 29. As shown in FIG. 29, the automated driving ECU 17k includes the travel environment recognition unit 171, a behavior determination unit 172k, the control implementation unit 173, and the HCU communication unit 174j as functional blocks. The automated driving ECU 17k includes the behavior determination unit 172k in place of the behavior determination unit 172. The automated driving ECU 17k includes the HCU communication unit 174j in place of the HCU communication unit 174. The automated driving ECU 17k is identical with the automated driving ECU 17e in the eighth embodiment except these respects. The automated driving ECU 17k is also equivalent to the control device for a vehicle. Execution of the processing of each functional block of the automated driving ECU 17k by the computer is also equivalent to execution of the control method for a vehicle.

The HCU communication unit 174j includes a notification processing unit 1741 and the setting request unit 1742 as sub-functional blocks. The HCU communication unit 174j is identical with the HCU communication unit 174j in the thirteenth embodiment. The setting request unit 1742 in the fourteenth embodiment can send an instruction to the HCU 10k to cause the notification device 18 to make a setting request.

The behavior determination unit 172k includes the setting state determination unit 1721, the searcher determination unit 1722, the LC restriction unit 1723, and a speed limitation unit 1725 as sub-functional blocks. The behavior determination unit 172k is identical with the behavior determination unit 172 in the eighth embodiment except that the speed limitation unit 1725 is provided.

When a destination is newly searched for in mode A or mode B based on a setting state determined at the setting state determination unit 1721 or when in mode C, the speed limitation unit 1725 causes a speed of the subject vehicle to be limited to a speed lower than a set vehicle speed for automated driving free from a monitoring obligation. That is, when a destination is newly searched for in mode A or mode B or when in mode C, a speed of the subject vehicle is limited more than when these conditions are not met. For example, a vehicle speed specified according to a speed limit of a traveling road of the subject vehicle can be taken as a set vehicle speed for automated driving free from a monitoring obligation. A vehicle speed set by input operation of an occupant may be taken as a set vehicle speed for automated driving free from a monitoring obligation. A speed of the subject vehicle can be limited by setting a speed upper limit value lower than a set vehicle speed. Aside from the foregoing, a speed of the subject vehicle may be limited by decelerating the subject vehicle.

In a case where a destination is newly searched for when the subject vehicle is in mode A or in mode B, a planned route is highly possibly changed. Also, when in mode C, a planned route is highly possibly changed. When a planned route is changed as mentioned above, a sudden change of traveling direction may be required. According to the above-mentioned configuration, a sudden change of traveling direction can also be easily coped with by limiting a speed of the subject vehicle.

In a case where a setting request is not caused at the setting request unit 1742, even when a destination is newly searched for in mode A or mode B or when in mode C, the speed limitation unit 1725 preferably prevents a speed of the subject vehicle from being limited. That is, when a new destination is searched for, that is, reroute is performed by setting of a destination by an occupant without a setting request, a speed of the subject vehicle is prevented from being limited. In other words, when a new destination is searched for, that is, reroute is performed by setting of a destination by an occupant after a setting request, a speed of the subject vehicle is limited.

When a setting request is made from the system side of a vehicle, it is guessed that the setting request is highly urgent. According to the above-mentioned configuration, a speed of the subject vehicle can be limited only when a destination is searched for, that is, reroute is performed in such a situation that an occupant is prone to panic. Therefore, a situation in which the subject vehicle is requested to cope with sudden driving operation when an occupant is prone to panic can be made less prone to occur. Meanwhile, when a destination has been set by an occupant and the subject vehicle is not in a situation in which an occupant is prone to panic, a speed of the subject vehicle need not be limited. As a result, irritation to an occupant that can be caused by limiting a speed can be suppressed.

The configuration of the fourteenth embodiment may be combined with the configurations of the twelfth to thirteenth embodiments. The configuration of the fourteenth embodiment may be combined with the configurations of the first to seventh, and ninth to eleventh embodiments. In relation to the fourteenth embodiment, a configuration in which the automated driving ECU 17k bears the functions of the setting state determination unit 1721, the speed limitation unit 1725, and setting request unit 1742 has been described but the present disclosure need not be configured as mentioned above. For example, the present disclosure may be so configured that at least some of the functions of the setting state determination unit 1721, the speed limitation unit 1725, and setting request unit 1742 are born by the HCU 10, 10a, 10b, 10c, 10d, 10f, 10g, 10h. The functions of the setting state determination unit 1721 can be born by the same functional block as the setting state determination unit 106 in the HCU 10, 10a, 10b, 10c, 10d, 10f, 10g, 10h. The functions of the speed limitation unit 1725 can be born by the same functional block as the control instruction unit 180 in the HCU 10, 10a, 10b, 10c, 10d, 10f, 10g, 10h. The functions of the setting request unit 1742 can be born by the same functional block as the notification control unit 100, 100a, 100b, 100c, 100d, 100f, 100g, 100h in the HCU 10, 10a, 10b, 10c, 10d, 10f, 10g, 10h. In this case, a configuration embracing the HCU 10, 10a, 10b, 10c, 10d, 10f, 10g, 10h, or the HCU 10, 10a, 10b, 10c, 10d, 10f, 10g, 10h and the automated driving ECU 17k is equivalent to the control device for a vehicle.

### (Fifteenth Embodiment)

The present disclosure need not be configured as in the above-mentioned embodiments and may be configured as in the fifteenth embodiment described below. Hereafter, a description will be given to an example of a configuration of the fifteenth embodiment. The fifteenth embodiment is based on the assumption that a mobile terminal of an occupant of the subject vehicle and the vehicular system 1, 1c, 1d, 1e, 1f, 1g, 1h, 1i, 1j, 1k can be communication-connected with each other. Examples of mobile terminals include such multifunctional portable telephones as smartphones. It is assumed that the mobile terminal has a navigation function. This communication connection can be implemented, for example, by short-range communication. Examples of short-range communication include radio communication in accordance with the Bluetooth Low Energy (Bluetooth is a registered trademark) standard. In this case, the vehicular system 1, 1c, 1d, 1e, 1f, 1g, 1h, 1i, 1j, 1k can be communication-connected with the mobile terminal, for example, through a short-range communication module.

The HCU 10, 10a, 10b, 10c, 10d, 10e, 10f, 10g, 10h, 10i, 10j, 10k determines whether route guidance is provided at the mobile terminal. The determination can be made from information related to the navigation function at the mobile terminal, acquired from the mobile terminal. Even when the mobile terminal and the vehicular system 1, 1c, 1d, 1e, 1f, 1g, 1h, 1i, 1j, 1k are communication-connected with each other, route search at the mobile terminal is not reflected in a traveling plan at the automated driving ECU 17, 17e. Notification notifying that route search at the mobile terminal is not reflected in a traveling plan at the automated driving ECU 17, 17e, 17f, 17h, 17i, 17j, 17k will be hereafter referred to as non-reflection notification. When it is determined that route guidance is provided at the portable terminal, the HCU 10, 10a, 10b, 10c, 10d, 10e, 10f, 10g, 10h, 10i, 10j, 10k causes the notification device 18 to make non-reflection notification. According to the foregoing, a misunderstanding that route search at a portable terminal is reflected in a traveling plane at the automated driving ECU 17, 17e, 17f, 17h, 17i, 17j, 17k can be prevented from being given to an occupant.

Note that the present disclosure is not limited to the embodiments described above and can variously be modified within the scope of the present disclosure. An embodiment obtained by appropriately combining the technical features disclosed in different embodiments may also be included in the technical scope of the present disclosure. The control device, control unit and the control method described in the present disclosure may be implemented by a special purpose computer which includes a processor programmed to execute one or more functions executed by computer programs. Alternatively, the device and the method thereof described in the present disclosure may also be implemented by a dedicated hardware logic circuit. Alternatively, the device and the method thereof described in the present disclosure may also be implemented by one or more dedicated computers configured as a combination of a processor executing a computer program and one or more hardware logic circuits. The computer programs may be stored, as instructions to be executed by a computer, in a tangible non-transitory computer-readable storage medium.

What is claimed is:

1. A vehicular control device used in a vehicle with which automated driving without a monitoring obligation, which is automated driving during which a surround monitoring obligation is not imposed, is performed, the vehicular control device comprising:
a guidance provision determination unit that is configured to determine whether route guidance to a destination set by an occupant of the vehicle is under way; and
a notification control unit that is configured to, when the guidance provision determination unit determines that the route guidance is not under way during the automated driving without a monitoring obligation of the vehicle, cause prompting notification, which is at least either confirmation notification prompting confirmation related to setting of a route or situation notification notifying of a traveling situation, at a predetermined timing.

2. The vehicular control device according to claim 1, wherein
when the guidance provision determination unit determines that the route guidance is not under way during the automated driving without a monitoring obligation of the vehicle, the notification control unit causes the prompting notification on time timing, as the predetermined timing, which correspond to time when an elapsed time from start of the automated driving without a monitoring obligation reaches a specified time.

3. The vehicular control device according to claim 1, wherein
when the guidance provision determination unit determines that the route guidance is not under way during the automated driving without a monitoring obligation of the vehicle, the notification control unit causes the prompting notification on mileage timing, as the predetermined timing, which corresponds to time when a mileage of the vehicle from start of the automated driving without a monitoring obligation reaches a specified distance.

4. The vehicular control device according to claim 1, wherein
when the guidance provision determination unit determines that the route guidance is not under way during the automated driving without a monitoring obligation of the vehicle, the notification control unit causes notification of the information of a predetermined point through which the vehicle is planned to pass as the situation notification at predetermined timing intervals from start of the automated driving without a monitoring obligation as the predetermined timing.

5. The vehicular control device according to claim 1, wherein
when the guidance provision determination unit determines that the route guidance is not under way during the automated driving without a monitoring obligation of the vehicle, the notification control unit causes the prompting notification on place timing, which corresponds to time when the vehicle arrives at a predetermined place that is a predetermined area or spot, as the predetermined timing.

6. The vehicular control device according to claim 5 further comprising:
a speed control instruction unit that is configured to, when a distance between the vehicle and the predetermined place become equal to a threshold value or below, suppress a speed of the vehicle to a specified value or below,
wherein
when the guidance provision determination unit determines that the route guidance is not under way during the automated driving without a monitoring obligation of the vehicle, the notification control unit causes the situation notification notifying of a traveling situation on place timing, which corresponds to time when the vehicle arrives at the predetermined place.

7. The vehicular control device according to claim 1, wherein
when the prompting notification is caused, the notification control unit sequentially causes a plurality of types of the prompting notification including at least two types of notification from among setting prompting notification prompting setting of a destination as the confirmation notification, setting state notification notifying of a present route setting state as the confirmation notification, and the situation notification.

8. The vehicular control device according to claim 1, wherein
the notification control unit causes setting prompting notification prompting setting of a destination as the prompting notification, and
when the guidance provision determination unit determines that the route guidance is not under way during the automated driving without a monitoring obligation of the vehicle, the notification control unit causes at least either setting state notification notifying of a present route setting state or a situation notification notifying of a traveling situation from before the predetermined timing, and the notification control unit causes the setting prompting notification at the predetermined timing.

9. The vehicular control device according to claim 1, wherein
when the guidance provision determination unit determines that the route guidance is not under way during the automated driving without a monitoring obligation of the vehicle, the notification control unit is capable of causing, as the prompting notification, at least one of setting prompting notification prompting setting of a destination as the confirmation notification, setting state notification notifying of a present route setting state as the confirmation notification, and the situation notification on at least two types of timing, as the predetermined timing, from among time timing, which corresponds to time when an elapsed time from start of the automated driving without a monitoring obligation reaches a specified time, mileage timing, which corresponds to a mileage of the vehicle from start of the automated driving without a monitoring obligation reaches a specified distance, and place timing, which corresponds to time when the vehicle arrives at a predetermined place that is a predetermined area or spot, and varies a type or a combination of types of the prompting notification according to on which type of the timing the prompting notification is caused.

10. The vehicular control device according to claim 1, further comprising:
a repetition determination unit that is configured to determine whether the vehicle is traveling along a route along which the vehicle has repetitively traveled a predetermined number of times or more in past,
wherein
even in a case where the guidance provision determination unit determines that the route guidance is not under way during the automated driving without a monitoring obligation of the vehicle, when the repetition determination unit determines that the vehicle is traveling along a route along which the vehicle has repetitively traveled in the past, the notification control unit prevents the prompting notification from being caused at the predetermined timing.

11. The vehicular control device according to claim 1, wherein
the vehicular control device can be used in a vehicle in which of the automated driving without a monitoring obligation, sleep-permitted automated driving during which a driver of the vehicle is permitted to sleep and sleep-prohibited automated driving during which a driver of the vehicle is not permitted to sleep can be switched therebetween and be performed,
wherein
when the guidance provision determination unit determines that the route guidance is not under way during the automated driving without a monitoring obligation of the vehicle, the notification control unit varies a frequency of notification notifying that the vehicle is not providing the route guidance as the situation notification according to whether the vehicle is during the sleep-permitted automated driving or during the sleep-prohibited automated driving.

12. The vehicular control device according to claim 11, wherein
when the vehicle is during the sleep-permitted automated driving, the notification control unit increases a frequency of notification notifying that the vehicle is not providing the route guidance as the situation notification as compared with a case where the vehicle is during the sleep-prohibited automated driving.

13. The vehicular control device according claim 1, wherein
when a non-route guidance transition, which is a transition from a state in which the guidance provision determination unit determines that the route guidance is under way to a state in which the guidance provision determination unit determines that the route guidance is not under way, is made during the automated driving without a monitoring obligation of the vehicle, the notification control unit causes at least either setting prompting notification prompting setting of a destination as the confirmation notification or notification confirming whether to continue the automated driving without a monitoring obligation of the vehicle.

14. The vehicular control device according to claim 13, comprising:
a continuation determination unit that is configured to, when the non-route guidance transition is made during the automated driving without a monitoring obligation of the vehicle, determine whether to continue the automated driving without a monitoring obligation according to at least either a driver operation related to a second task, which is an action other than driving permitted to the driver of the vehicle, or the steering operation of the driver.

15. The vehicular control device according to claim 14, wherein
when the driver operation related to the second task takes place, the continuation determination unit determines that the automated driving without a monitoring obligation is continued and causes the automated driving without a monitoring obligation to be continued, and
when the steering operation by the driver takes place, the continuation determination unit determines that the automated driving without a monitoring obligation is not continued and causes a transition to driving change.

16. A vehicular control device used in a vehicle with which automated driving without a monitoring obligation, which is automated driving during which a surround monitoring obligation is not imposed, is performed, the vehicular control device comprising:
a setting state determination unit that is configured to determine a setting state which is a state related to setting of a destination of the vehicle; and
an allowable range alteration unit that is configured to alter an allowable range of second tasks, which are actions other than driving permitted to a driver of the vehicle, between a first mode which is a state of the vehicle during the automated driving without a monitoring obligation with the destination set by an occupant of the vehicle and a second mode which is a state of the vehicle during the automated driving without a monitoring obligation without a destination set by an occupant of the vehicle based on the setting state determined at the setting state determination unit.

17. The vehicular control device according to claim 16, wherein
in the second mode, the allowable range alteration unit narrows an allowable range of the second tasks as compared with an allowable range of the second tasks in the first mode.

18. The vehicular control device according to claim 16, wherein
in the second mode, the allowable range alteration unit widens an allowable range of the second tasks as compared with an allowable range of the second tasks in the first mode.

19. The vehicular control device according to claim 16, wherein
when reroute, which is re-search for a new route to a destination, takes place, the vehicle makes a transition to a third mode that is a state of the vehicle during the automated driving without a monitoring obligation, different from the first mode and the second mode, and
in the third mode, the allowable range alteration unit narrows an allowable range of the second tasks as compared with allowable ranges of the second tasks in the first mode and the second mode.

20. The vehicular control device according to claim 19, wherein
in the third mode, the allowable range alteration unit prevents execution of the second task from being permitted.

21. A vehicular control device used in a vehicle with which automated driving without a monitoring obligation, which is automated driving during which a surround monitoring obligation is not imposed, is performed, the vehicular control device comprising:
a setting state determination unit that is configured to determine a setting state which is a state related to setting of a destination of the vehicle; and
a lane change restriction unit that is configured to restrict execution of a lane change of the vehicle in a case where a destination is being newly searched for in a first mode, which is a state of the vehicle during the automated driving without a monitoring obligation with a destination set by an occupant of the vehicle, or in a second mode, which is a state of the vehicle during the automated driving without a monitoring obligation without a destination set by an occupant of the vehicle or in a third mode, which is a state of the vehicle during the automated driving without a monitoring obligation, different from the first mode and the second mode, to which a transition is made when reroute, which is re-search for a new route to a destination, takes place based on the setting state determined at the setting state determination unit.

22. The vehicular control device according to claim 21, comprising:
a notification instruction unit that when the lane change restriction unit restricts execution of the lane change, notifies that execution of the lane change is restricted.

23. The vehicular control device according to claim 21, comprising:
a searcher determination unit that determines in accordance with whichever's instruction, a driver of the vehicle or a passenger other than the driver, search for the destination is made,
wherein
in a case where the searcher determination unit determines that search for the destination is made in accordance with the driver's instruction, the lane change restriction unit causes execution of the lane change to be restricted when the destination is newly searched for in the first mode or in the second mode; and in a case where the searcher determination unit determines that search for the destination is made in accordance with the passenger's instruction, the lane change restriction unit prevents execution of the lane change from being restricted even when the destination is newly searched for in the first mode or in the second mode.

24. The vehicular control device according to claim 21, comprising:
a setting request unit that causes a setting request requesting setting of the destination, higher in urgency than setting prompting notification prompting setting of the destination, to be made toward an occupant of the vehicle,
wherein
when the setting request unit does not cause the setting request to be made, the lane change restriction unit prevents execution of the lane change from being restricted.

25. The vehicular control device according to claim 1, comprising:
a setting state determination unit that determines a setting state which is a state related to setting of a destination of the vehicle; and
a speed limitation unit that limits a speed of the vehicle to a value lower than a set vehicle speed during the automated driving without a monitoring obligation when a destination is newly searched for in first mode, which is a state of the vehicle during the automated driving without a monitoring obligation with the destination set by an occupant of the vehicle, or second mode, which is a state of the vehicle during the automated driving without a monitoring obligation without the destination set by an occupant of the vehicle, or when in third mode, which is a state of the vehicle during the automated driving without a monitoring obligation, different from the first mode and the second mode, to which a transition is made when reroute, which is re-search for a new route to a destination, takes place based on the setting state determined at the setting state determination unit.

26. The vehicular control device according to claim 25, comprising:
a setting request unit that is configured to cause a setting request requesting setting of the destination, higher in urgency than setting prompting notification prompting setting of the destination, to be made toward an occupant of the vehicle,
wherein
when the setting request unit prevents the setting request from being made, the speed limitation unit prevents the speed from being limited.

27. The vehicular control device according to claim 16, comprising:
a notification instruction unit that is configured to, when a non-route guidance transition, which is a transition from a state in which it is determined that route guidance to a destination set by an occupant of the vehicle is under way to a state in which it is determined that the route guidance is not under way, is made during the automated driving without a monitoring obligation of the vehicle, cause at least either setting prompting notification prompting setting of a destination or notification confirming whether to continue the automated driving without a monitoring obligation.

28. The vehicular control device according to claim 27, comprising:
a continuation determination unit that is configured to, when the non-route guidance transition is made during the automated driving without a monitoring obligation of the vehicle, determine whether to continue the automated driving without a monitoring obligation according to at least either the driver operation related to a second task, which is an action other than driving permitted to a driver of the vehicle, or the steering operation of the driver.

29. The vehicular control device according to claim 28, wherein
when the driver operation related to the second task takes place, the continuation determination unit determines that the automated driving without a monitoring obligation is continued and continues the automated driving without a monitoring obligation, and
when the steering operation by the driver takes place, the continuation determination unit determines that the automated driving without a monitoring obligation is not continued and causes a transition to driving change.

30. A vehicular control method used in a vehicle that performs automated driving without a monitoring obligation which is automated driving during which a surround monitoring obligation is not imposed, the control method being executed by at least one processor, the vehicular control method comprising:
a guidance provision determination step of determining whether route guidance to a destination set by an occupant of the vehicle is under way; and
a notification control step of, when it is determined that the route guidance is not under way at the guidance provision determination step during the automated driving without a monitoring obligation of the vehicle, causing prompting notification which is at least either confirmation notification prompting confirmation related to setting of a destination or situation notification notifying of a traveling situation at a predetermined timing.

31. A vehicular control method used in a vehicle that performs automated driving without a monitoring obligation which is automated driving during which a surround monitoring obligation is not imposed, the control method being executed by at least one processor, the vehicular control method comprising:
a setting state determination step of determining a setting state which is a state related to setting of a destination of the vehicle; and
an allowable range alteration step of altering an allowable range of second tasks which are actions other than driving permitted to a driver of the vehicle between a first mode which is a state of the vehicle during the automated driving without a monitoring obligation with the destination set by an occupant of the vehicle and a second mode which is a state of the vehicle during the automated driving without a monitoring obligation without the destination set by an occupant of the vehicle based on the setting state determined at the setting state determination step.

32. A vehicular control method used in a vehicle that performs automated driving without a monitoring obligation which is automated driving during which a surround monitoring obligation is not imposed, the control method being executed by at least one processor, the vehicular control method comprising:
a setting state determination step of determining a setting state which is a state related to setting of a destination of the vehicle; and
a lane change restriction step of restricting execution of a lane change of the vehicle in a case where the destination is newly searched for in a first mode which is a state of the vehicle during the automated driving without a monitoring obligation with the destination set by an occupant of the vehicle or in a second mode which is a state of the vehicle during the automated driving without a monitoring obligation without the destination set by an occupant of the vehicle, or in a third mode which is a state of the vehicle during the automated driving without a monitoring obligation, different from the first mode and the second mode, to which a transition is made when reroute, which is re-search for a new route to a destination in the first mode, takes place based on the setting state determined at the setting state determination step.
